(19) United States
(12) Patent Application Publication
(10) Pub. No.: US 2026/0279918 A1
(43) Pub. Date: Sep. 17, 2026

(54) Methods of Forming a Via and/or Current Collector Trace in a Solid-State Battery

(71) Applicant: Ensurge Micropower ASA, Oslo (NO)

(72) Inventor: Ravi BILLA, San Jose, CA (US)

(21) Appl. No.: 19/564,610

(22) Filed: Mar. 12, 2026

Related U.S. Application Data
(60) Provisional application No. 63/770,491, filed on Mar. 12, 2025.

(51) Int. Cl. H01M 10/0585; H01M 4/02; H01M 4/505; H01M 4/525; H01M 4/58; H01M 4/66; H01M 4/82; H01M 10/052; H01M 10/0562

(52) U.S. Cl. CPC H01M 10/0585; H01M 4/505; H01M 4/525; H01M 4/5825; H01M 4/662; H01M 4/663; H01M 4/82; H01M 10/052; H01M 10/0562; H01M 2004/027; H01M 2004/028; H01M 2300/0077

(57) ABSTRACT

Methods of making solid-state battery cells using a sacrificial or conductive via, and related solid-state battery cells, are disclosed. One method includes forming a patterned anode current collector (ACC) layer on a solid-state electrolyte, forming a sacrificial material in a first pattern on the patterned ACC layer, depositing an encapsulant on the sacrificial material and the patterned ACC layer, and irradiating the sacrificial material with a laser sufficiently to ablate the sacrificial material and form openings in the encapsulant exposing each ACC in the patterned ACC layer. The solid-state electrolyte is on a cathode layer, which is in turn on a substrate. The openings in the encapsulant form a pattern substantially corresponding to the first pattern. An alternative method substitutes a non-sacrificial conductive via for the sacrificial material, forming the conductive via in an opening in the encapsulant, or exposing the conductive via through the encapsulant.

### CROSS-REFERENCE TO RELATED APPLICATION(S)

This application claims the benefit of U.S. Provisional Pat. Appl. No. 63/770,491, filed Mar. 12, 2025, pending, incorporated herein by reference in its entirety.

### TECHNICAL FIELD

The present disclosure generally relates to the field of solid-state and/or thin-film batteries. More specifically, embodiments of the present disclosure pertain to methods of making a via and/or a current collector trace in a solid-state battery, and in particular, using a laser to pattern an opening in an insulator layer to expose the current collector and form the via and/or the current collector trace therein.

### SUMMARY

The present disclosure relates to solid-state and thin film batteries, and more specifically to a solid-state battery and methods of making the same using a laser and a sacrificial layer to pattern openings in an insulating encapsulant material. The present disclosure improves the formation of the patterned openings in the encapsulant material by using the sacrificial layer (also in a pattern corresponding to the pattern of the openings) to selectively absorb light from the laser, to ablate the sacrificial layer, and break open the encapsulant material above the sacrificial layer. When the encapsulant material has sufficient brittleness and/or fracturability, the encapsulant material breaks relatively cleanly, perhaps as a result of forces applied to the encapsulant material from the thermal expansion of the sacrificial layer (and, in many embodiments, stress points in the encapsulant material). Besides achieving a dry, high-fidelity pattern with reduced (or no) damage to the underlying battery cell, this approach is also advantageous for patterning flexibility, lower cost, and higher throughput, since the laser ablation process does not require fabricating a physical photolithography mask.

Thus, in one aspect, the disclosure relates to a method of making solid-state battery cells, comprising forming a patterned anode current collector (ACC) layer on a solid-state electrolyte, forming a sacrificial material in a first pattern on the patterned ACC layer, depositing an insulating encapsulant material on the sacrificial material and the patterned ACC layer, and irradiating the sacrificial material with a laser sufficiently to ablate the sacrificial material and form openings in the encapsulant material exposing a part of each ACC in the patterned ACC layer. The openings in the encapsulant material are in a second pattern corresponding to or substantially corresponding to the first pattern. The solid-state electrolyte is on a cathode layer, and the cathode layer is on a substrate. The ACCs in the patterned ACC layer define the solid-state battery cells, in which each ACC defines an individual solid-state battery cell.

The cathode layer may be blanket-deposited onto the substrate, and the solid-state electrolyte may be blanket-deposited onto the cathode layer. The sacrificial material may be formed in the first pattern by selective deposition (e.g., printing or physical vapor deposition [PVD] through a shadow mask), or by blanket deposition (e.g., chemical vapor deposition [CVD] or sol-gel processing) and photolithographic patterning.

In some embodiments, the sacrificial material may be ablated using a programmable laser patterning device. In such embodiments, the method may further comprise programming the programmable laser patterning device. For example, the programmable laser patterning device may be programmed to irradiate the locations of the first pattern with a dose of light having a wavelength absorbed by (e.g., at or near an absorption maximum of) the sacrificial material sufficient to ablate the sacrificial material and remove the encapsulant material above the sacrificial material. In some instances, some of the encapsulant material adjacent to the sacrificial material may also be removed. In various examples, the wavelength of the light from the laser may range from infrared or red (e.g., 800-1400 nm) to ultraviolet (e.g., 240-400 nm), the pulse length of the laser can be nanosecond (e.g., 1-1000 ns), picosecond (e.g., 5-1000 ps), or femtosecond (e.g., 5-5000 femtoseconds), the pulse frequency may be in the range of 10⁵-10¹⁴ Hz (depending on the pulse length), and the laser power may be in the range of 10-1000 W.

The encapsulant material may be formed or deposited along the ACC edges or sidewalls of the cells. In some embodiments, the encapsulant material is conformally deposited onto the battery cells, including on the ACC edges or sidewalls of the cells. Typically, the encapsulant comprises an electrically-insulating film that also functions as a moisture barrier. For example, the encapsulant may comprise a moisture-repellant or moisture-resistant polyolefin, parylene, or a halogenated variation thereof (e.g., parylene-C or parylene-F), a silicon oxide and/or nitride, etc.

In some embodiments, the method further comprises forming a redistribution layer on the ACC and the encapsulant. The redistribution layer is formed on (e.g., in contact with) the ACC exposed through the opening, and when the encapsulant is along the ACC edge or sidewall, the redistribution layer may also be formed on the encapsulant along the ACC edge or sidewall. In some embodiments, the redistribution layer comprises an elemental metal or an alloy thereof (e.g., an alloy consisting essentially of elemental metals). In various embodiments, the redistribution layer is formed by sputtering, atomic layer deposition (ALD), or thermal evaporation, followed by photolithographic patterning and etching. Alternatively, the redistribution layer may be formed by selective deposition, such as inkjet printing, aerosol-jet printing, or screen printing. In certain embodiments, the redistribution layer has a thickness of 0.25-2.0 μm.

The method may further comprise cutting or dicing the solid-state battery cells through the electrolyte and the cathode material in the pattern to form a cathode in and/or to singulate the solid-state battery cells (or rows or columns thereof). The method may also further comprise cleaning the battery cells (e.g., the encapsulant and exposed areas of the ACC) prior to and/or following any of the processing steps in the method, singulating the (encapsulated) battery cells, and/or packaging the singulated battery cells. The method may also further comprise stacking the singulated battery cells, prior to packaging the stacked battery cells.

In some embodiments of the method, the ACC material may be blanket-deposited and laser-patterned using a second programmable laser patterning device. For example, the second programmable laser patterning device may be programmed to form polylines in the ACC material. The polylines may comprise a first plurality of parallel lines along a first direction and a second plurality of parallel lines along a second direction, and the second direction may be orthogonal to the first direction. However, the first and second pluralities of parallel lines may not form sharp corners in the patterned ACCs. In other or further examples, the first and second pluralities of parallel lines may have a width of 2-50 μm, independent of each other (individually or as one of the pluralities, in which each of the first plurality of parallel lines has a first width, and each of the second plurality of parallel lines has a second width independent of the first width). The parameters for the laser and the light emitted thereby for forming the polylines in the ACC material (e.g., wavelength, pulse length, pulse frequency, and laser power) may be within the ranges disclosed herein.

In some embodiments of the method, cutting or dicing the battery cells comprises cutting or dicing the battery cells through the substrate every other cell (or every other row or column of cells) to form ACC edges or sidewalls of the battery cells. In such embodiments, cutting or dicing the battery cells may form dual cells or rows or columns of cell pairs.

In some embodiments of the method, singulating the encapsulated battery cells comprises laser dicing, mechanical dicing, or stamping. For example, singulating the encapsulated battery cells may comprise cutting or dicing the dual cells or dual rows or columns of cells through the substrate to form CCC edges or sidewalls in the battery cells. In further embodiments, the method may further comprise stacking and/or packaging the singulated battery cells. The singulated battery cells may comprise singulated rows or columns of the battery cells. The stacked battery cells may have all of the ACC edges or sidewalls on a first side of the stacked battery cells, and all of the CCC edges or sidewalls on a second side of the stacked battery cells.

In some embodiments, stacking the singulated battery cells comprises depositing an adhesive (e.g., an epoxy adhesive) on a first one of the singulated battery cells, and placing a next one of the singulated battery cells on the first one of the singulated battery cells. Optionally, the method may further comprise stacking one or more of the singulated battery cells on the next one of the singulated battery cells until the last one of the singulated battery cells is stacked. In other or further embodiments, stacking the singulated battery cells further comprises placing a dummy cell on the last one of the singulated battery cells. In various embodiments, placing the next one of the singulated battery cells on the first one of the singulated battery cells comprises a pick-and-place operation. In other embodiments, when the singulated battery cells comprise a row or column of cells, stacking the singulated battery cells may comprise strip folding or strip stacking the row or column of cells.

In some embodiments, the cathode material comprises a lithium metal oxide or lithium metal phosphate, such as lithium cobalt oxide (LCO), lithium manganese oxide (LMO), or lithium iron phosphate (LFP). In other or further embodiments, blanket-depositing the cathode material may comprise laser deposition, sputtering, chemical vapor deposition (CVD), sol-gel processing, screen printing, inkjet printing, spray coating, or extrusion coating.

In some embodiments, the solid-state electrolyte comprises lithium phosphorus oxynitride (LiPON), carbon-doped LiPON, Li₂WO₄, or one or more layers of a lithium lanthanum zirconium oxide (LLZO), in which some of the Zr may be substituted with one or more of niobium, tantalum, aluminum, gallium, indium, vanadium, antimony, or hafnium. In other or further embodiments, blanket-depositing the solid-state electrolyte comprises depositing a LiPON layer or a tungsten oxide layer of the formula WO₃₊ₓ (0≤x≤1) by sputtering or atomic layer deposition (ALD), or depositing one or more LLZO layers by one or more sol-gel techniques. When blanket-depositing the solid-state electrolyte comprises depositing the tungsten oxide layer, blanket-depositing the solid-state electrolyte may comprise sputtering using a metallic or elemental tungsten target in an oxygen-containing atmosphere to form the tungsten oxide layer, then lithiating and thermally annealing the tungsten oxide layer. In some embodiments, the method further comprises forming an interface material comprising a lithiated metal oxide on the cathode material and/or the solid-state electrolyte.

In some embodiments, the ACC material comprises a conductive metal, such as nickel, zinc, copper, tungsten, vanadium, an alloy of one or more of these metals, or graphite. When the ACC material is a conductive metal, the conductive metal is incapable of forming an alloy with lithium. The ACC material may be deposited by spray coating, sputtering, evaporation, CVD, or ALD, and may have a thickness of 0.1-5 μm.

In some embodiments, the substrate comprises a metal foil. For example, the metal foil may function as a cathode current collector in each of the battery cells. In such embodiments, the method may further comprise forming a diffusion barrier on one or both major surfaces of the metal foil prior to blanket-depositing the cathode material. In various examples, the metal foil comprises elemental aluminum, copper, titanium, nickel, iron, or an alloy thereof (e.g., stainless steel). For example, the metal foil may have a thickness of 10-100 μm. In embodiments including the diffusion barrier, the method may further comprise depositing an insulation layer, such as a silicon oxide, on the diffusion barrier. Thus, in some embodiments, the diffusion barrier may comprise a metal nitride or a combination of the metal nitride and a silicon oxide (e.g., alternating diffusion barrier and insulation layers).

In another aspect, the disclosure relates to an alternative method of making solid-state battery cells, comprising forming a patterned anode current collector (ACC) layer on a solid-state electrolyte, forming a conductive via or contact and an insulating encapsulant on the patterned ACC layer, and forming a redistribution layer on the conductive via or contact and the encapsulant, including along an ACC edge or sidewall of each of the solid-state battery cells. As for the first method, the solid-state electrolyte is on a cathode layer, the cathode layer is on a substrate, and each of the solid-state electrolyte and the cathode layer may be blanket-deposited. The encapsulant (i) surrounds and exposes the conductive via or contact and (ii) is further on the solid-state electrolyte and along the ACC edges or sidewalls of the solid-state battery cells.

In some embodiments, forming the conductive via or contact and the insulating encapsulant on the patterned ACC layer comprises depositing the encapsulant on the patterned ACC layer, the electrolyte and the ACC edges or sidewalls, forming an opening in the encapsulant exposing the patterned ACC layer, and either (i) depositing a metal containing ink or paste in the opening by a precision dispensing technique, then optionally annealing or curing the metal containing ink or paste, or (ii) blanket depositing a conductive material into the opening and onto the encapsulant, and removing excess conductive material from an uppermost surface of the encapsulant by planarization (e.g., grinding or polishing). In other embodiments, forming the conductive via or contact and the insulating encapsulant on the patterned ACC layer comprises forming the conductive via or contact in a first pattern on the patterned ACC layer (e.g., similarly to the sacrificial material), and depositing the encapsulant on the patterned ACC layer, the electrolyte, and the ACC edges or sidewalls. The encapsulant may be deposited by either (i) printing the encapsulant in a second pattern including an opening through which the conductive via or contact is exposed, or (ii) blanket-depositing the encapsulant on the conductive via or contact, the patterned ACC layer, the electrolyte and the ACC edges or sidewalls, and removing the encapsulant from an uppermost surface of the conductive via or contact by planarization. Otherwise, the alternative method is at least somewhat similar or substantially similar to the first method.

In yet another aspect, the present disclosure concerns a solid-state battery cell, comprising a substrate, a cathode on the substrate, a solid-state electrolyte on the cathode, an anode current collector (ACC) on the solid-state electrolyte, an encapsulant on the ACC with a fractured opening therein exposing an upper surface of the ACC, and a redistribution layer electrically connecting the ACC to a first sidewall of the solid-state battery cell. The electrolyte and the cathode are co-extensive (i.e., have the same width, the same length, and aligned sidewalls). In some embodiments, the solid-state battery cell further comprises a metal substrate, and the encapsulant is on the first sidewall of the solid-state battery cell, covering the sidewalls of the ACC, the electrolyte, the cathode, and the metal substrate. The redistribution layer is on the encapsulant on the first sidewall, and the metal substrate may have an exposed sidewall surface on a second sidewall of the solid-state battery cell, opposite from the first sidewall.

In a still further aspect, the present disclosure concerns an alternative solid-state battery cell, comprising a substrate, a cathode on the substrate, a solid-state electrolyte on the cathode, an anode current collector (ACC) on the solid-state electrolyte, an encapsulant on the ACC with an opening therein exposing an upper surface of the ACC, a conductive via or contact in the opening in electrical contact with the ACC, and a redistribution layer electrically connecting the conductive via or contact to a first sidewall of the solid-state battery cell. The alternative solid-state battery cell is otherwise somewhat similar or substantially similar to the first solid-state battery cell with the fractured opening(s) in the encapsulant.

Compared to photolithographically-patterned openings in the encapsulant material having otherwise identical properties and characteristics, the fractured openings have peripheral edges or sidewalls with a greater variance (e.g., from linearity and/or planarity) and sharper uppermost edges (i.e., the angles between the major surface away from the ACC and the sidewalls), and may have average dimensions (e.g., height and/or width) at its uppermost surfaces or edges that are larger than those of photolithographically-patterned openings. Compared to an encapsulant printed in a pattern including the openings and having otherwise identical properties and characteristics, the encapsulant material having fractured openings has generally greater purity and/or better electrical properties. The present solid-state battery cell may further comprise any of the other structures and materials described herein.

Other capabilities and advantages of the present disclosure will become readily apparent from the detailed description of various embodiments below.

### BRIEF DESCRIPTION OF THE DRAWINGS

FIGS. 1-3 are cross-sectional views of structures in an exemplary method of making solid-state battery cells, according to embodiments of the present disclosure.

FIGS. 4A-B are cross-sectional and layout (top-down) views of the exemplary structure of FIG. 3, with patterned ACCs thereon, in accordance with embodiments of the present disclosure.

FIGS. 5A-B are cross-sectional and layout views of the exemplary structure of FIGS. 4A-B, with a patterned sacrificial material thereon, in accordance with embodiments of the present disclosure.

FIGS. 6A-B are cross-sectional and layout views of the exemplary structure of FIGS. 5A-B, diced or cut to form cell pair strips and ACC edges, in accordance with embodiments of the present disclosure.

FIGS. 7A-B are cross-sectional and layout views of the exemplary structure of FIGS. 6A-B, with an encapsulant on the patterned ACCs, the patterned sacrificial material, and the ACC edges of the cells, in accordance with embodiments of the present disclosure.

FIG. 8 is a cross-sectional view of the exemplary structure of FIGS. 7A-B after laser ablation of the patterned sacrificial material, in accordance with one or more embodiments of the present disclosure.

FIGS. 9A-B are cross-sectional and layout views of the exemplary structure of FIG. 8 following formation of patterned redistribution layer(s) thereon, in accordance with embodiments of the present disclosure.

FIGS. 10A-B are cross-sectional and layout views of the exemplary structure of FIGS. 9A-B following singulation to form single-cell strips (or individual battery cells) and CCC edges in/on the cells, in accordance with embodiments of the present disclosure.

FIGS. 11-12 are cross-sectional views of exemplary structures in an alternative method of making solid-state battery cells, in accordance with one or more alternative embodiments of the present disclosure.

FIGS. 13-23 are cross-sectional views of exemplary structures in a further alternative method of making solid-state battery cells, in accordance with one or more further embodiments of the present disclosure.

### DETAILED DESCRIPTION

Reference will now be made in detail to various disclosed examples, examples of which are illustrated in the accompanying drawings. While the disclosure will be described in conjunction with the following embodiments, it will be understood that the descriptions are not intended to limit the disclosed examples. On the contrary, the disclosure is intended to cover alternatives, modifications, and equivalents that may be included within the spirit and scope of the disclosure. Furthermore, in the following detailed description, numerous specific details are set forth in order to provide a thorough understanding of the present disclosure. However, it will be readily apparent to one skilled in the art that the present disclosure may be practiced without these specific details. In other instances, well-known methods, procedures, and components have not been described in detail so as not to unnecessarily obscure aspects of the present disclosure. Furthermore, it should be understood that the possible permutations and combinations described herein are not meant to limit the disclosure. Specifically, variations that are not inconsistent may be mixed and matched as desired.

The technical proposal(s) of embodiments of the present disclosure will be fully and clearly described in conjunction with the drawings in the following embodiments. It will be understood that the descriptions are not intended to limit the disclosed examples. Based on the described embodiments of the present disclosure, other embodiments can be obtained by one skilled in the art without creative contribution and are within the scope of legal protection given to the present disclosure.

Furthermore, all characteristics, measures, or processes disclosed in this document, except characteristics and/or processes that are mutually exclusive, can be combined in any manner and in any combination possible. Any characteristic disclosed in the present specification, claims, Abstract, and Figures can be replaced by other equivalent characteristics or characteristics with similar objectives, purposes, and/or functions, unless specified otherwise.

For the sake of convenience and simplicity, the term “length” generally refers to the largest dimension of a given 3-dimensional structure or feature. The term “width” generally refers to the second largest dimension of a given 3-dimensional structure or feature. The term “thickness” generally refers to the smallest dimension of a given 3-dimensional structure or feature. The length and the width, or the width and the thickness, may be the same in some cases. A “major surface” refers to a surface defined by the two largest dimensions of a given structure or feature, which, in the case of a structure or feature having a circular surface, may be defined by the radius or diameter of the circle.

In addition, for convenience and simplicity, the terms “part,” “portion,” and “region” may be used interchangeably, but these terms are also generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The present disclosure concerns a solid-state battery containing an encapsulation layer with fractured (e.g., laser-fractured) openings and methods of making the same using a sacrificial material, which is laser-ablated in the methods. The present solid-state battery includes, in some embodiments, an intrinsic anode-less battery comprising a substrate (which can also serve or function as a cathode current collector [CCC]), a cathode or cathode layer, a solid-state electrolyte (SSE) or solid-state electrolyte, and an anode current collector (ACC). In anode-less embodiments, no lithium anode is formed between the SSE and the ACC during manufacturing. A lithium anode may form during or upon completion of a battery charging operation.

The following discussion provides examples of manufacturing processes for solid-state battery cells and batteries, as well as variations of the processes.

FIG. 1 is a cross-sectional view showing an exemplary substrate 100 for the processes, comprising a metal foil, sheet, or substrate 110 and optional first and second barriers 115a-b on opposite major surfaces of the metal foil, sheet, or substrate 110. When the foil, sheet, or substrate 110 is a metal foil, the first barrier 115a is not optional. The metal foil may comprise or consist essentially of stainless steel, aluminum, copper, nickel, inconel, brass, molybdenum or titanium, the elemental metals of which may be alloyed with up to 10% of one or more other elements to improve one or more physical and/or chemical properties thereof (e.g., oxygen and/or water permeability, flexibility, resistance to corrosion or chemical attack during subsequent processing, etc.). However, the substrate 110 can also be a metal sheet or a metal roll. For example, the foil or film may be 10-100 μm thick, whereas a metal sheet may have a thickness of >100 μm, up to about 1-2 mm. Other alternative substrates include a metal coating on a mechanical substrate, such as aluminum, copper, nickel, titanium, etc., on a removable plastic film, sheet, or roll.

The barrier 115a-b comprises one or more layers of one or more materials in a thickness effective to prevent migration of atoms or ions from the metal foil, sheet, or substrate 110 into overlying layers. The barrier material(s) may comprise a glass or ceramic, such as silicon dioxide, aluminum oxide, silicon nitride, a silicon and/or aluminum oxynitride, etc., or a (refractory) metal nitride, such as aluminum nitride, titanium nitride, titanium aluminum nitride, tungsten nitride, titanium tungsten nitride, TiW alloy, tantalum nitride, etc. In some embodiments, each of the first and second barriers 115a-b comprises alternating glass/ceramic and metal nitride layers (e.g., a first metal nitride layer, a first glass/ceramic layer, and a second metal nitride layer, which may further comprise a second glass/ceramic layer, a third metal nitride layer, etc.). Each barrier 115a or 115b may have a total thickness of 0.05-3 μm, but the barrier 115a-b is not limited to this range. The barriers 115a-b may be blanket-deposited onto the foil, sheet, or substrate 110 by chemical or physical vapor deposition (e.g., sputtering, thermal evaporation, atomic layer deposition [ALD], etc.), solution-phase coating with a precursor material followed by annealing to form the glass/ceramic or metal nitride, etc.

In some embodiments, the foil, sheet, or substrate 110 functions as a cathode current collector. In such embodiments, at least the barrier 115a (and optionally the barrier 115b) is or includes a conductive, amorphous material, such as the refractory metal nitrides listed above or an amorphous metal alloy (e.g., a TiW alloy).

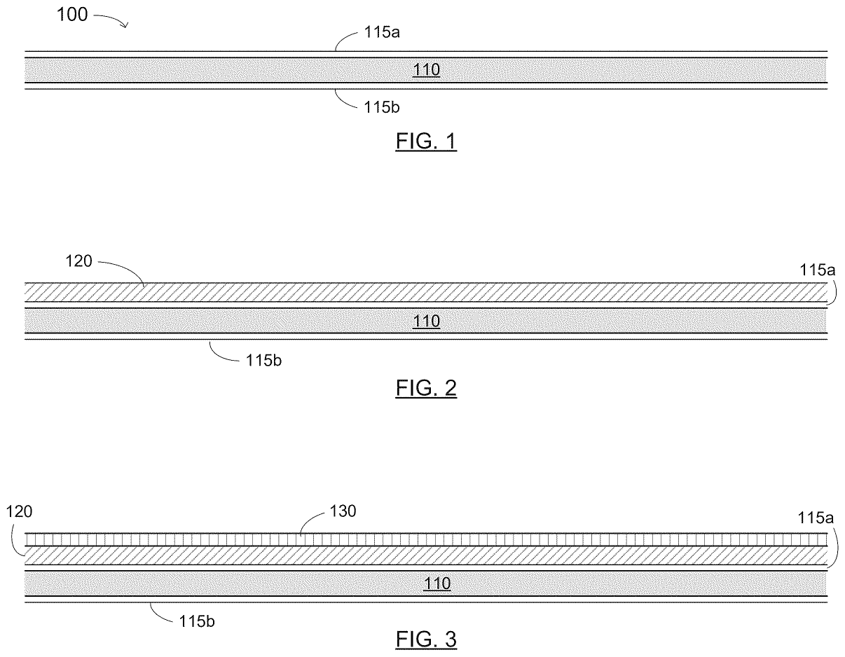

FIG. 2 shows the metal substrate 100 with a cathode 120 thereon. The cathode 120 may comprise a lithium metal oxide or lithium metal phosphate, such as lithium cobalt oxide (LiCoO₂; LCO), lithium manganese oxide (LiMn₂O₄; LMO), or lithium iron phosphate (LiFePO₄; LFP), for example. The cathode 120 may be blanket deposited by laser deposition (e.g., pulsed laser deposition or PLD), sputtering, chemical vapor deposition (CVD), sol-gel processing, etc. Alternatively, the cathode 120 may be selectively deposited by screen printing, inkjet printing, spray coating, or extrusion coating (e.g., using an ink comprising one or more sol-gel precursors and one or more solvents, having a viscosity appropriate for the printing or coating technique). After deposition, the cathode 120 may be annealed (e.g., at a temperature of 500-800° C., or any temperature or range of temperatures therein) for a length of time sufficient to achieve a predetermined or desired crystalline structure.

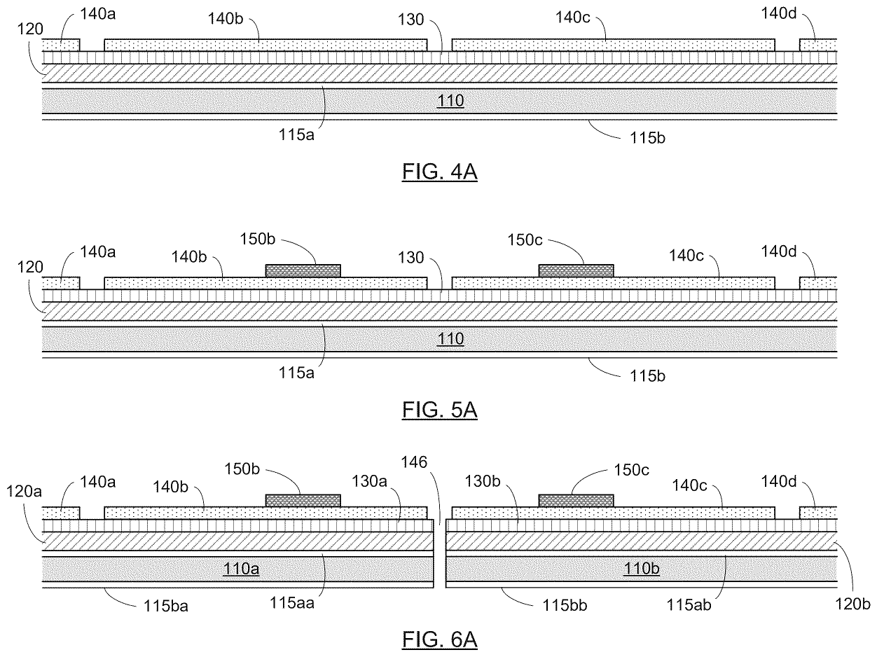

FIG. 3 shows a solid-state electrolyte 130 on the cathode 120. The solid-state electrolyte 130 may comprise or consist essentially of a conventional lithium phosphorus oxynitride (LiPON, which may optionally be carbon-doped) or Li₂WO₄, a good Li-ion conductor. Alternatively, the electrolyte 130 may comprise or consist essentially of one or more layers of a lithium lanthanum zirconium oxide (LLZO; e.g., Li₇La₃Zr₂O₁₂ in which some part or fraction of the Zr atoms may be substituted with one or more of niobium, tantalum, aluminum, gallium, indium, vanadium, antimony, or hafnium) or other garnet-type oxide electrolyte. In some examples, solid-state electrolytes 130 may comprise or consist essentially of a NASICON (sodium superionic conductor), a sulfide-based inorganic electrolyte, a LISICON (lithium superionic conductor), or a solid inorganic-polymer composite electrolyte including one or more of the inorganic electrolytes mentioned herein.

In some embodiments, the electrolyte 130 may further comprise optional cathode and/or anode interface layers (not shown), each of which may comprise a lithiated metal oxide. For example, a metal oxide (e.g., NbO₂, Al₂O₃, Li₄Ti₅O₁₂, or LiNbO₃) interlayer may be formed on the cathode 120 prior to deposition of the electrolyte 130 (e.g., to reduce interfacial stress, decrease interfacial resistance, or suppress formation of a space charge layer). Alternatively or additionally, an amorphous (e.g., elemental silicon) interlayer may be deposited on the electrolyte 130 prior to formation of the anode current collector layers 140 to inhibit reduction of the electrolyte 130. In some embodiments, thermal annealing can modify the interface(s) between the layers of the cell, which can significantly reduce charge transfer resistance.

Forming the electrolyte 130 may comprise depositing a LiPON layer or a tungsten oxide layer of the formula WO₃₊ₓ (0≤x≤1) by sputtering, optionally using pulsed DC power. When the electrolyte 130 comprises LiPON, it may be deposited by RF sputtering or ALD. The sputtering target may comprise a Li₃PO₄ or mixed graphite-Li₃PO₄ target, the latter of which may contain 1-15 wt % of graphite, when the electrolyte 130 comprises LiPON or carbon-doped LiPON, and a metallic/elemental tungsten target when the electrolyte 130 comprises a tungsten oxide. In the latter case, sputtering is performed in an oxygen or oxygen-containing atmosphere. The method of making the electrolyte 130 may further comprise lithiating and thermally annealing the WO₃₊ₓ, which can transform it into Li₂WO₄, a good Li-ion conductor. Lithiating may comprise wet lithiation (e.g., immersing the WO₃₊ₓ in a solution containing a lithium electrolyte such as LiClO₄, LiPF₆, LiBF₄, etc., and applying an appropriate electric field) or dry lithiation (e.g., sputtering or thermally evaporating elemental lithium onto the tungsten oxide in a vacuum chamber, optionally while heating the substrate 310). Thermal annealing may comprise heating at a temperature of 150-500° C. for a length of time of 5-240 minutes, or any temperature or length of time therein (e.g., 250-450° C. for 10-120 minutes), in a conventional oven, a vacuum oven, or a furnace. To ensure substantially complete diffusion of the lithium into and/or throughout the WO₃₊ₓ, the WO₃₊ₓ should be annealed (preferably in air) at a temperature of at least 100° C. for at least 10 minutes (e.g., to transform it into Li₂WO₄).

An LLZO electrolyte 130 may be formed by depositing an LLZO sol-gel (e.g., by spic-coating, extrusion coating, dip-coating, drip-casting, etc.), then annealing at a temperature in the range of 500-800° C., or any value or range of values therein for 1-60 minutes in an oxygen-containing gas such as clean dry air (CDA).

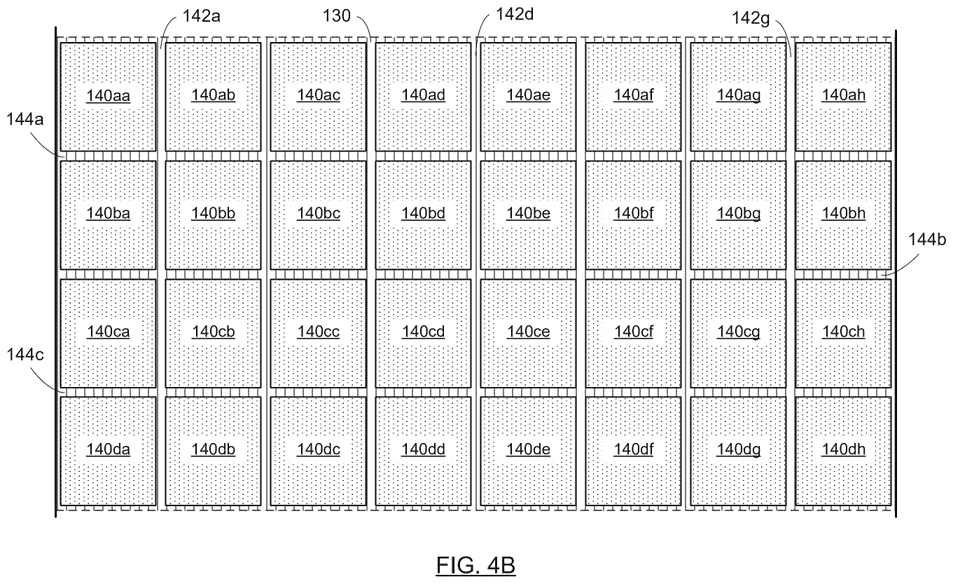

FIG. 4A shows an anode current collector (ACC) layer 140a-d formed in a pattern on the electrolyte 130, and FIG. 4B shows a layout of the patterned ACCs 140aa-dh on a partial substrate (under the electrolyte 130) in the form of a sheet or roll. A separately-formed anode is not necessary in solid-state lithium batteries, as a lithium anode can be formed between the electrolyte 130 and the ACCs 140a-d (or 140aa-dh) during charging, if necessary. Optionally, however, a thin lithium anode can be deposited by evaporation onto the electrolyte 130 prior to formation (e.g., blanket-deposition and subsequent patterning) of the ACC layer 140. Alternatively, a thin silicon seed layer may be blanket-deposited onto the electrolyte 130 prior to deposition of the ACC layer 140. The silicon seed layer may be deposited by chemical vapor deposition (CVD; e.g., from silane gas), atomic layer deposition (ALD), coating from a liquid-phase silane such as trisilane, tetrasilane, cyclopentasilane, etc. The silicon seed layer may have a thickness of from 20 to 500 Å or any thickness or range of thicknesses therein (e.g., 50-200 Å).

The anode current collector layer 140 generally comprises a conductive metal, such as nickel, zinc, copper, tungsten, vanadium, alloys thereof (e.g., NiTi, NiV), etc., or another conductor, such as graphite. Preferably, the conductive metal for the anode current collector layer 140 is incapable of forming an alloy with lithium (e.g., a non-Li alloying metal or alloy). Prior to patterning, the anode current collector layer 140 can be deposited by spray coating or other blanket deposition technique (e.g., sputtering, evaporation, chemical vapor deposition [CVD], or atomic layer deposition [ALD]). The anode current collector layer 140 may have a thickness of 0.1-5 μm, although it is not limited to this range.

The battery may further include one or more interlayers that modify the interfaces between different functional layers. For example, a metal oxide (e.g., Nb₂O₅, Al₂O₃, Li₄Ti₅O₁₂ or LiNbO₃) interlayer may be formed on the cathode 320 prior to deposition of the electrolyte 130 (e.g., to reduce interfacial stress, decrease interfacial resistance, or suppress formation of a space charge layer). An amorphous (e.g., elemental silicon) interlayer may be deposited on the electrolyte 130 prior to formation of the anode current collector layer 140 to inhibit reduction of the electrolyte. Of course, the battery cell can be made in the reverse order (i.e., the anode current collector may be first formed on the substrate, then the remaining layers deposited in reverse order thereon).

An advantage of some embodiments of the present method is that all of the active battery layers (e.g., the cathode 120, the solid-state electrolyte 130, and the ACC layer 140) may be deposited as blanket layers. This maximizes the active area utilization of the battery cells for high intrinsic capacity, and also results in a topographically planar or “flat” cell to facilitate formation of the uppermost layer(s) and downstream packaging due to the pattern-free blanket-deposited layers. Even after patterning, the patterned ACCs 140a-d/140aa-dh introduce relatively minimal topographic changes to the structure (e.g., the sheet or roll of battery cells).

In various embodiments, the blanket-deposited ACC layer may be patterned by laser ablation/patterning or low-resolution photolithographic patterning. The ACC layer may be laser-patterned with light having a wavelength of 240-1400 nm, a pulse length of 5 femtoseconds to 1000 ns, a pulse frequency of 10⁵-10¹⁴ Hz, and/or a power of 10-1000 W. The ACC layer may be photolithographically patterned, e.g., by coating a photoresist on the blanket-deposited ACC layer, irradiating selected portions of the photoresist, developing the photoresist to expose the portions of the blanket-deposited ACC layer to be removed, removing the exposed portions of the blanket-deposited ACC layer by etching (e.g., dry or plasma-assisted etching), removing the remaining photoresist by ashing, and optionally cleaning the resulting structure shown in FIGS. 4A-B. Alternatively, the patterned ACCs 140a-d/140aa-dh can be formed directly by printing (e.g., inkjet printing a metal-containing ink, screen printing a metal paste, etc.), followed by curing or annealing, as needed or desired.

FIG. 4B is a layout view of the battery cell structure of FIG. 4A expanded across a width dimension of the substrate. ACCs 140aa-dh correspond to individual battery cells, and are separated from each other by first (e.g., vertical) gaps 142a-g and second (e.g., horizontal) gaps 144a-c exposing the solid-state electrolyte 130. The ACCs 140aa-dh at this stage may have area dimensions (i.e., length and width dimensions) that are 75-98% of the corresponding length and width dimensions, respectively, of the cells. The pull-back distance of the ACCs 140aa-dh from the cell edges should be sufficient to electrically isolate the ACCs from the CCC/substrate 110.

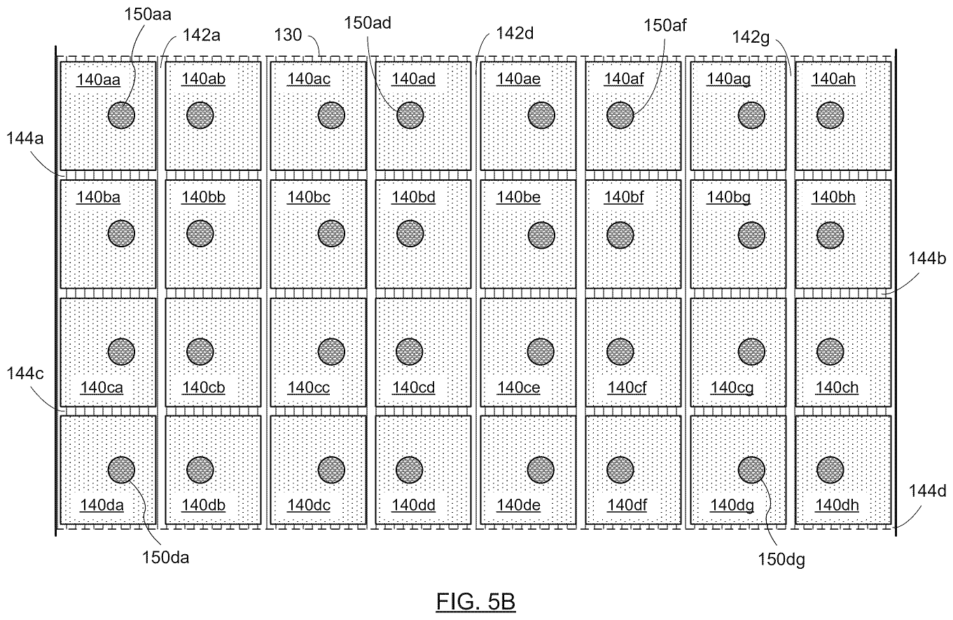

FIGS. 5A-B show the battery cells of FIGS. 4A-B, respectively, with a patterned sacrificial material layer 150b-c or 150aa-dh thereon. In some examples, each ACC 140a-d or 140aa-dh has one corresponding sacrificial material unit 150 thereon (not shown on ACCs 140a and 140d). The patterned sacrificial material layer 150b-c/150aa-dh is preferably formed by selective deposition, such as PVD through a shadow mask, inkjet printing, screen printing, nozzle dispensing, or another direct patterning method, using an ink or paste including the sacrificial material. Alternatively, the sacrificial material layer may also be blanket-deposited and patterned by low-resolution photolithography, as described herein.

The sacrificial material layer 150b-c/150aa-dh has few restrictions other than being (1) a solid material at ambient temperature (e.g., in a range of 25-100° C. or greater), (2) light absorbing (e.g., with a high absorption coefficient, or at or near a local absorption maximum) at a wavelength of the light from the laser (e.g., in the UV to near-IR regions of the spectrum, as described herein), and (3) having a positive coefficient of thermal expansion (e.g., at least 10 μm/m·° C. or 10 ppm/° C., such as 20 ppm/° C., 50 ppm/° C., 100 ppm/° C., or more). In general, the sacrificial material and the laser are selected so that one or more peak absorption wavelengths of the sacrificial material match one or more wavelengths of the laser used to ablate the sacrificial material. Suitable sacrificial materials include conducting and semiconducting organic polymers (e.g., poly(3,4-ethylene-dioxythiophene) [PEDOT], poly(3-hexylthiophene) [P3HT], poly({4,8-bis[(2-ethylhexyl)oxy]benzo[1,2-b:4,5-b′]dithiophene-2,6-diyl}{3-fluoro-2-[(2-ethylhexyl)car-bonyl]thieno[3,4-b]thiophenediyl}) [PTB7], ), C₆₀ and derivatives thereof (e.g., phenyl-C₆₁-butyric acid methyl ester [PCBM]), photovoltaic and semiconducting inorganic compounds such as alkylammonium lead halides (e.g., [MeNH₃]Pbl₃) and other perovskites and metal and/or metalloid chalcogenides (e.g., zinc sulfide, Cu₂ZnSnS₄, molybdenum sulfide, tungsten oxide, vanadium oxide), graphene and oxides thereof, and other light-absorbing semiconducting materials such as black phosphorous.

Furthermore, many polymers (e.g., polyvinyl chloride [PVC], poly [acrylonitrile-butadiene-styrene] [ABS], polyacrylates [PA], polymethacrylates [PMA], cellulose and derivatives thereof [e.g., cellulose acetate], epoxy polymers, polyethylene [PE], polypropylene [PP], polyethylene glycol [PEG], polyvinyl alcohol [PVA], polyamides, polyimides, polycarbonates [PC], polyesters such as polyethylene terephthalate [PET], polystyrene [PS], polystyrene sulfonate [PSS], copolymers thereof, blends thereof, etc.) have coefficients of thermal expansion exceeding 50 or 100 μm/m·° C. or ppm/° C., and may be useful as a binder for the light-absorbing material. Such polymer binders can stabilize the structure of the sacrificial material layer 150b-c/150aa-dh and/or modify one or more of the properties of the sacrificial material layer 150b-c/150aa-dh as described herein. Mixing a light-absorbing sacrificial material such as graphite, carbon black, or other conventional light-absorbing material (see Tables 1 and 2 below) with a polymer binder (e.g., PVC, PA, PMA, PC, PVP) can result in a material that expands relatively rapidly on absorption of light from the laser and quickly imparts an appreciable force on the overlying encapsulant.

In addition, a solvent and, optionally, a stabilizer can facilitate dissolution and dispersion of the sacrificial material and binder (e.g., particles thereof), as well as film formation and processing (see Table 2 below). Both solvents and binders are useful for solution processing of the sacrificial material.

TABLE 1

| | Absorption | | Wavelength(s) |
|---|---|---|---|
| Material | Range | Laser Type | (nm) |
| Poly(3,4-ethylene- | Visible to | Nd:YAG, ArF | 1064, 193 |
| dioxythiophene):polystyrene | near-IR | Excimer | |
| sulfonate (PEDOT:PSS) | | | |
| Poly(3-hexylthiophene) (P3HT) | 450-600 | Frequency- | 532, 248 |
| | nm | doubled Nd:YAG, | |
| | | KrF Excimer | |
| Phenyl-C₆₁-butyric acid methyl ester | UV-visible | KrF Excimer, ArF | 248, 193 |
| (PCBM) | | Excimer | |
| Poly({4,8-bis [(2- | Visible to | Nd:YAG, | 1064, 800 |
| ethylhexyl)oxy]benzo[1,2-b:4,5- | near-IR | Ti:Sapphire | |
| b′]dithiophene-2,6-diyl}{3-fluoro-2- | | | |
| [(2-ethylhexyl)carbonyl]thieno[3,4- | | | |
| b]thiophenediyl}) (PTB7) | | | |
| (H₃CNH₃)Pbl₃ | Visible | Frequency-tripled | 355 |
| | | Nd:YAG | |
| PbS (e.g., quantum dots) | Visible to | CO₂, Nd:YAG | 10600, 1064 |
| | mid-IR | | |
| Cu₂ZnSnS₄ (CZTS) | Visible | Frequency- | 532 |
| | | doubled Nd:YAG | |
| Graphene oxide | Visible to | CO₂, Nd:YAG | 10600, 1064 |
| | IR | | |
| MoS₂ (e.g., nanosheets) | Visible to | Nd:YAG, | 1064, 800 |
| | near-IR | Ti:Sapphire | |
| Black phosphorous | Near-IR to | CO₂, fiber laser | 10600, 1030 |
| | mid-IR | | |
| WO₃ (e.g., nanoparticles) | Near-IR to | CO₂, fiber laser | 10600, 1030 |
| | mid-IR | | |
| VO₂ (e.g., nanoparticles) | Near-IR to | CO₂, Nd:YAG | 10600, 1064 |
| | mid-IR | | |

TABLE 2

| Material | Solvent(s) | Binder(s)/Stabilizer(s) |
|---|---|---|
| Poly(3,4-ethylene- | Water, C₁-C₄ alcohols | [PSS] |
| dioxythiophene):polystyrene | | |
| sulfonate (PEDOT:PSS) | | |
| Poly(3-hexylthiophene) (P3HT) | C₁-C₄ haloalkanes, benzene, | PVP |
| | benzene substituted with | |
| | up to 3 chlorine atoms | |
| Phenyl-C₆₁-butyric acid methyl ester | Benzene, benzene | [None] |
| (PCBM) | substituted with up to 3 | |
| | chlorine atoms | |
| Poly({4,8-bis[(2- | Benzene, benzene | PS |
| ethylhexyl)oxy]benzo[1,2-b:4,5- | substituted with up to 3 | |
| b′]dithiophene-2,6-diyl}{3-fluoro-2- | chlorine atoms | |
| [(2-ethylhexyl)carbonyl]thieno[3,4- | | |
| b]thiophenediyl}) (PTB7) | | |
| (H₃CNH₃)Pbl₃ | Dimethyl formamide (DMF), | PVP, PEG |
| | dimethyl sulfoxide, C₁-C₄ | |
| | alcohols | |
| PbS (e.g., quantum dots) | C₆-C₁₀ alkanes and | C₁₂-C₂₀ saturated and |
| | cycloalkanes | unsaturated alkanoic |
| | | acids; tri-C₆-C₁₀-alkyl |
| | | phosphine oxides |
| Cu₂ZnSnS₄ (CZTS) | Water, C₁-C₄ alcohols | PVP |
| Graphene oxide | Water, DMF | PVA |
| MoS₂ (e.g., nanosheets) | Water, C₁-C₄ alcohols | Alkali metal salts of bile |
| | | acids (e.g., sodium |
| | | cholate) |
| Black phosphorous | N-methyl pyrrolidone | PVP, surfactant(s) |
| | (NMP), C₁-C₄ alcohols | |
| WO₃ (e.g., nanoparticles) | Water, C₁-C₄ alcohols | PVA |
| VO₂ (e.g., nanoparticles) | C₃-C₄ ketones, C₁-C₄ | PVP, PEG-poly(propylene |
| | alcohols | oxide) copolymers (e.g., |
| | | Pluronic F127) |

The mixture of sacrificial material, solvent and (when present) binder and/or stabilizer may be deposited by spin-coating, blade coating, doctor blading, slot-die coating, spray coating, vapor-assisted deposition, drop casting, sol-gel deposition (e.g., of metal/metalloid chalcogenides capable of forming a sol and/or gel), deposition of a nanoparticle ink, liquid exfoliation, hydrothermal synthesis (e.g., of VO₂), or alternatively, by inkjet printing. When the mixture is deposited in an area having at least a width or length similar to or greater than that of an ACC, the sacrificial material mixture can be dried, coated with a photoresist, and conventionally patterned using low-resolution photolithography. In any case, when the sacrificial material mixture includes a solvent, it is dried (e.g., substantially all of the solvent is removed) by heating and/or application of reduced pressure (e.g., 200 torr or less) prior to further processing.

The sacrificial material layer 150b-c/150aa-dh may have nearly any thickness, as long as it is capable of fracturing the overlying encapsulant material upon being irradiated with light from the laser. For example, the sacrificial material layer 150b-c/150aa-dh may have a thickness of 0.2-5 μm, or any thickness or range of thicknesses therein. The patterned sacrificial material units 150b-c/150aa-dh should each have area dimensions (i.e., a length and a width) about the same as the target area dimensions of the fractured openings in the encapsulant. When printed, the sacrificial material units 150b-c/150aa-dh may have rounded upper corners, sloped sidewalls, a bell-shaped or dome-shaped cross-sectional profile, etc. In general, the more vertical the sidewalls and/or the sharper the upper corners of the patterned sacrificial material units 150b-c/150aa-dh, the closer the area dimensions of the fractured openings will be to the area dimensions of the patterned sacrificial material units 150b-c/150aa-dh (or the uppermost surfaces thereof, when the patterned sacrificial material units 150b-c/150aa-dh have distinguishable upper corners).

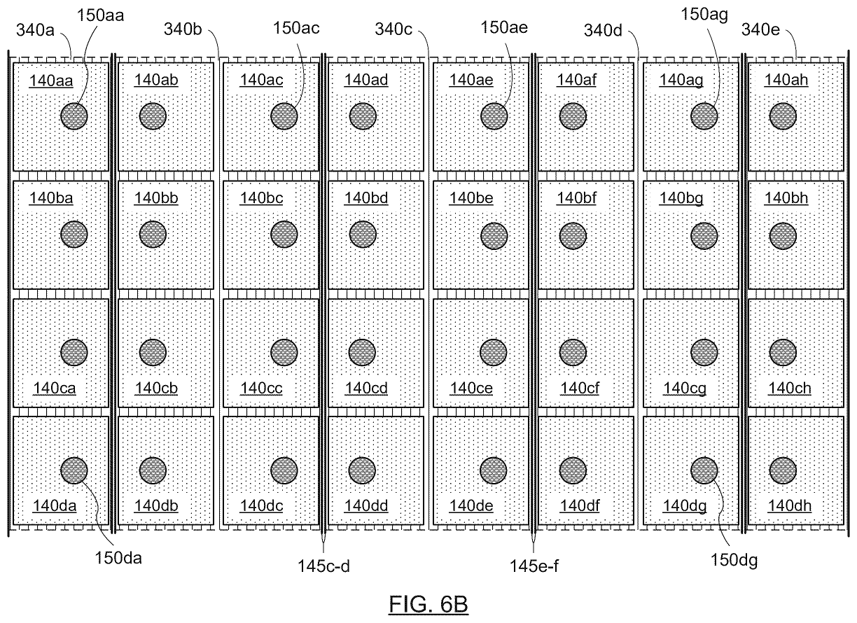

Referring to FIGS. 6A-B, the substrate 100 may be attached to a substrate support or holder (not shown), and the electrolyte 130, the cathode 120, and the substrate 100 (i.e., the metal foil sheet or roll 110 and barriers 115a-b) are cut or diced along lanes 142a, 142c, 142e, and 142g in FIG. 5B to form “ACC edges” 145a-h of the battery cells (FIG. 6B) and a gap 146 (FIG. 6A) every other cell, or every other row or column of cells (when the cells are in an array or on a multi-column roll; see FIG. 6B). As shown in FIG. 6B, the cuts may be made in the lanes between the first and second rows or columns, the next-to-last and last rows or columns, and every other lane therebetween, and such that the substrate is divided or separated into one or more strips of cell pairs and two single rows or columns of cells (e.g., the outermost rows or columns). For example, cell pairs 140ab-ac, 140bb-bc, 140cb-cc, and 140 db-dc form one cell pair strip. This step is also optional in the present method. When the substrate support is a tape or sheet, it is generally a UV release tape or sheet, containing an adhesive on one or both major surfaces that loses its adhesive properties upon sufficient irradiation with ultraviolet (UV) light. The tape or sheet may be on a ring or other frame, configured to mechanically support the tape or sheet and allow some tension therein and some light to pass through the underside of the tape or sheet. When the substrate support is a substrate holder (e.g., for cutting or dicing by stamping), it may comprise a magnetic plate or chuck.

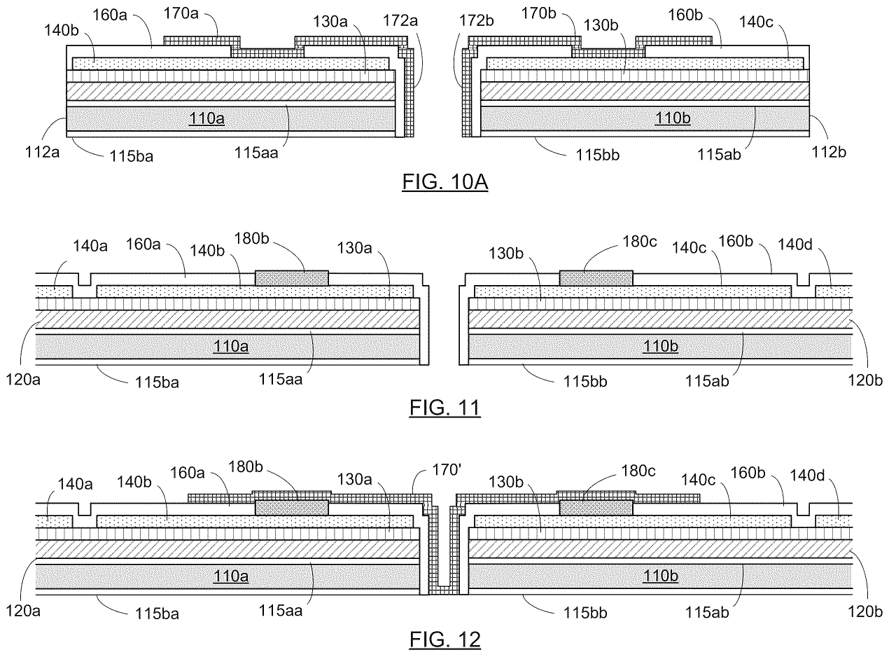

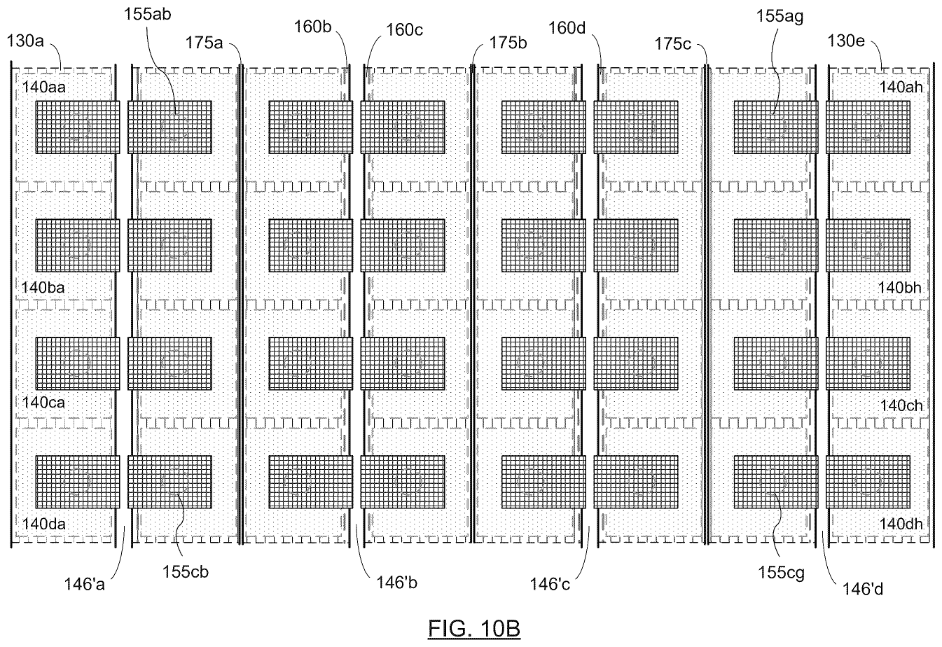

The gaps 146 may be cut by laser patterning or laser ablation, mechanical dicing or stamping, for example. When the cells are in an array or on a multi-column roll or sheet, they may also be cut or diced along the x-direction in FIG. 6B between adjacent cells (e.g., every row, between cells 140aa-ah and cells 140ba-bh, cells 140ba-bh and cells 140ca-ch, and cells 140ca-ch and cells 140da-dh) to form isolated cell pairs. The sidewalls 145a-h along the gaps 146 fully expose the entire cell stack, including the CCC/substrate 110. In a further option, the entire cell stack may be cut or diced between every column of cells, resulting in the formation of “CCC edges” (see, e.g., exposed CCC sidewalls 112a-b in FIG. 10A). FIG. 6B is a layout view of initially-separated single-cell (e.g., outermost) strips and cell pair strips from the partial sheet or roll in FIG. 5B.

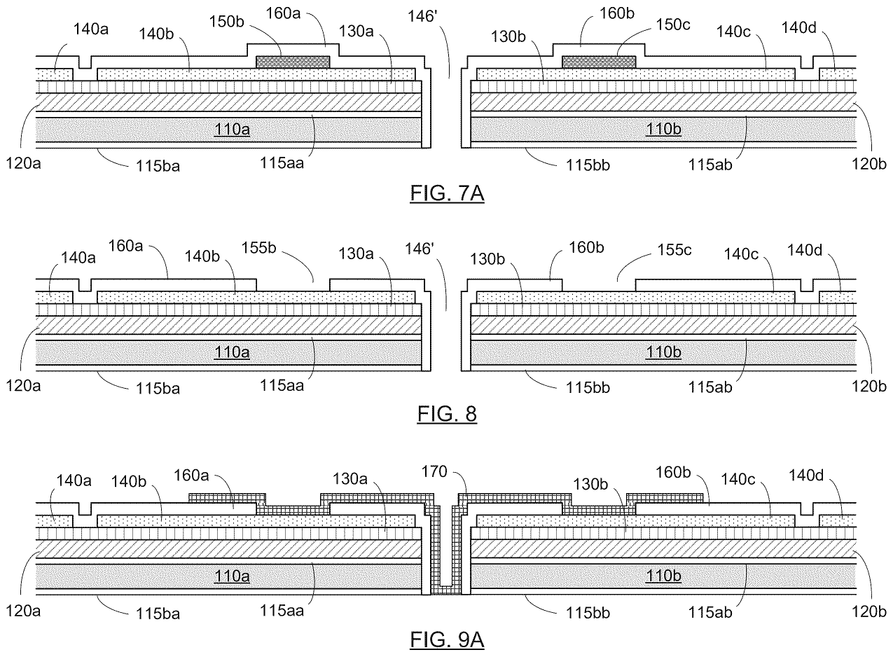

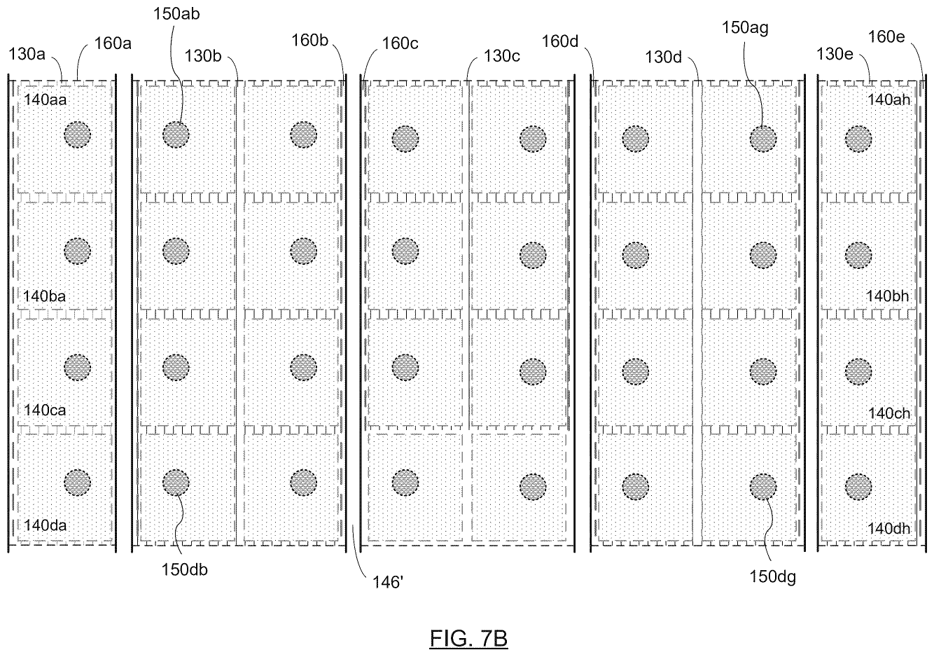

Referring now to FIG. 7A, the diced cell pairs (or strips of cell pairs) are substantially encapsulated with a moisture barrier and electrical insulation film 160a-b. The encapsulant film 160a-b may cover the front or uppermost surface of the cells and the exposed “ACC edges” or surfaces (e.g., 145a-h in FIG. 6B) of the cells facing the opening 146′ (FIGS. 7A-B). Optionally, the encapsulant film 160a-b may cover the backside surface of the cells, although this option is not shown in FIG. 7A. The encapsulant film 160a-b is deposited onto the cells, cell pairs, or cell strips by coating (e.g., extrusion coating, spin coating, drip/syringe coating, etc.) or other blanket-deposition technique.

The encapsulant film 160a-b may have certain properties (e.g., optical, thermal, mechanical, chemical and/or processing properties) facilitating the formation of openings over the sacrificial material layer 150b-c (150aa-dh in FIG. 7B). For example, the encapsulant film 160a-b may have an optical transparency at the wavelength of light emitted by the laser that allows the light to reach the sacrificial layer with minimal absorption or scattering by the encapsulant film 160a-b. The encapsulant film 160a-b may have a mechanical stability sufficient to maintain its physical state at the temperatures experienced during laser irradiation (e.g., a melting or decomposition temperature higher than the maximum temperature of the sacrificial material 150b-c during laser irradiation), and a thermal conductivity appropriate for laser fracturing (e.g., from 0.2 to 5.0 W m⁻¹ K⁻¹). The encapsulant film 160a-b may have a flexibility or rigidity and adhesion to underlying films and structures sufficient for it to maintain contact with the sacrificial material 150b-c and the ACCs 140a-d during the entirety of laser irradiation, a chemical compatibility with the sacrificial material 150b-c and the ACCs 140a-d sufficient to prevent or minimize chemical reactions between encapsulant film 160a-b and each of the sacrificial material 150b-c and the ACCs 140a-d, and/or an ability to be deposited at or otherwise formed with a controllable thickness. The encapsulant film 160a-b may also have properties adapted for protecting the battery cell after formation of the battery, such as a thickness of 0.2-5 μm (or any thickness or range of thicknesses therein), and/or a water vapor transmission rate (WVTR) in the range of 10⁻⁶ to 10⁻² g/m²/day (or any rate or range of rates therein), but the present disclosure is not limited to these ranges. Ultimately, though, the properties of the encapsulant film 160a-b should be selected and/or engineered so that the encapsulant film 160a-b fractures or breaks before the underlying layers fracture or break.

For example, the encapsulant film 160a-b may comprise a parylene, a polycarbonate, a poly(meth)acrylate, or other fracturable polyolefin, a fracturable inorganic insulator such as a silicon and/or aluminum dioxide and/or nitride, or a combination or laminate thereof. For example, when the encapsulant film 160a-b comprises a parylene, it may comprise poly-para-xylylene (N-parylene), poly(chloro-p-xylylene) (C-parylene), or poly(dichloro-p-xylylene (D-parylene). Other fracturable polyolefins include polyimides, poly(methyl methacrylate), and cross-linked, photoactivated, and/or thermally activated organic photoresists (e.g., bisphenol A-based novolac polymers with covalently-attached epoxy groups, such as SU-8, which can form highly vertical sidewalls upon fracturing). In addition, when the encapsulant film 160a-b comprises an inorganic insulator, it may comprise SiO₂ (e.g., which may be formed by heating a sol-gel containing a tetraalkyl silicate such as tetraethyl orthosilicate [TEOS]), a silicon nitride (which may be formed conformally, by CVD or ALD), or aluminum oxide.

When coated, the material(s) of the encapsulant film 160a-b may be dissolved or suspended in an appropriate solvent (e.g., one or more organic solvents, such as a C₆-C₁₀ alkane or cycloalkane, a C₁-C₆ halogenated alkane or cycloalkane including one or more halogen atoms and that is in the liquid phase at 25° C. and 1 atm pressure, a C₄-C₆ cyclic or acyclic ether, a C₄-C₁₀ cyclic or acyclic polyether, a C₁-C₁₀ cyclic or acyclic alkanol, a C₃-C₄ ketone, a C₆-C₁₀ arene substituted with 1-3 C₁-C₄ alkyl groups,) prior to printing. In certain embodiments, after coating or blanket deposition, the material for the encapsulant film 160a-b may be cured (e.g., by heating or irradiation with ultraviolet light) to provide certain desirable properties (e.g., a certain minimum hardness, an optical property, a minimum adhesion, etc.).

FIG. 7B is a layout view of the initially separated cell and cell pair strips of FIG. 10B, encapsulated with encapsulant films 160a-e. The encapsulant film 160a-e covers the entire cell or cell pair strip, including the sacrificial material units 150aa-dh, the ACCs 140aa-dh, and the solid-state electrolytes 130a-d. The outlines of the underlying sacrificial material units 150aa-dh, ACCs 140aa-dh, and electrolytes 130a-d are shown as dashed lines to indicate that they are covered by the respective encapsulant films 160a-e.

FIG. 8 is a cross-section of the battery cells of FIG. 7A after laser ablation of the sacrificial material layer 150b-c and formation of the openings 155b-c in the encapsulant layers 160a-b. The layout view of the structure in FIG. 8 is substantially identical to that shown in FIG. 7B, except that the sacrificial material layer 150aa-dh is removed, and the openings in the encapsulant layers 160a-e expose the upper surface of the ACCs 140aa-dh.

The sacrificial material layer 150b-c is ablated by irradiation with light from a programmable laser patterning device that is absorbed by the sacrificial material layer 150b-c or a component therein. The absorbed light is converted to heat, which causes the sacrificial material units 150b-c to expand and impart a force on the overlying encapsulant layers 160a-b. When the force from the thermal expansion of the sacrificial material units 150b-c is sufficiently great, the material of the overlying encapsulant layers 160a-b fractures or breaks, typically in locations of relatively high stress, such as at corners or edges of the sacrificial material units 150b-c and/or at bends in the encapsulant layers 160a-b next to the sacrificial material units 150b-c. Some material in the sacrificial material layer 150b-c may be ejected at the time that the encapsulant layers 160a-b fracture, and some may remain. Any material in the sacrificial material layer 150b-c remaining in the openings 155b-c continues to absorb light from the laser, eventually heating until the sacrificial material layer 150b-c liquifies and substantially completely vaporizes. As is known in the art, some materials absorb light at a higher efficiency in the liquid state than in the solid state, so materials with a relatively low melting point (e.g., 100-500° C., or any temperature or range of temperatures therein, such as 150-300° C.) may be preferred to materials with a relatively high melting point.

The programmable laser patterning device may irradiate structures using an ablation pattern (e.g., a graphical drawing representing the areas of the sacrificial material layer 150b-c to be irradiated and removed). The drawing may consist of a series of circles or other geometric shapes at positions corresponding to locations of the sacrificial material units (e.g., 150aa-dh in FIGS. 6B and 7B). Generally, to ensure complete vaporization of the sacrificial material layer 150a-b, the entire area of the sacrificial material layer 150a-b is irradiated. However, depending on the parameters and conditions of formation of the sacrificial material layer 150a-b, a peripheral area of each of the sacrificial material units 150a-b may not need to be irradiated.

In a representative example, the graphical drawing is in a format used by laser patterning or ablation tools, such as an Autocad.dxf or .dwg file. The graphical drawing comprises or consists of a series of geometric shapes having area dimensions that may be optimized for a given laser tool. Because there is no need for a mask, the ultimate shape of the sacrificial material units 150aa-dh (FIG. 6B) corresponding to openings 155a-b in the encapsulant layers 160a-b (FIG. 8) is somewhat arbitrary, and can be any shape that can be formed by the techniques for forming and irradiating the sacrificial material units 150aa-dh. The resulting shape of the openings 155a-b in the encapsulant layers 160a-b corresponds closely to that of the sacrificial material units 150aa-dh, but perhaps with a slightly larger amount of variability in its outline or border.

The laser beam profile is typically Gaussian or top hat, depending on the target profile for material removal. The spot or line widths to be irradiated may be in the range of 2-50 μm (or any width or range of widths therein, such as, e.g., 5-20 μm), depending on the laser beam spot size and energy profile. For example, the full width at half-maximum power (or half-power beam width) of the laser beam may be in the range of 2-50 μm, but it can be adjusted (increased or decreased) using focusing lenses.

The laser power and scan parameters may be optimized for a given laser wavelength and desired ablation depth. For example, the laser wavelength may range from infrared or red (e.g., 800-1400 nm) to ultraviolet (e.g., 240-400 nm). The pulse length of the laser can be nanosecond (e.g., 1-1000 ns, or any value or range of values therein), picosecond (e.g., 5-1000 ps, or any value or range of values therein), or femtosecond (e.g., 5-5000 femtoseconds, or any value or range of values therein). In working examples using an IR laser (e.g., wavelength in the range of 800-1400 nm), when the pulse length is in the femtosecond range, the pulse frequency may be in the range of 10⁹-10¹⁴ Hz (or any value or range of values therein), and when the pulse length is in the nanosecond range, the pulse frequency may be in the range of 10⁵-10⁹ Hz, or any value or range of values therein. In any case, the laser power may be in the range of 10-1000 W, or any value or range of values therein. One skilled in the art is capable of determining laser parameters that provide selectivity for the removal of the sacrificial material relative to the ACC material.

After laser patterning/ablation, debris removal or cleaning (if needed) may comprise dry etching (e.g., using an etch chemistry and conditions that are at least somewhat selective for removal of the sacrificial material relative to the ACC material), a high-velocity gas jet (e.g., a stream of dry CO₂, nitrogen or air), or by wet chemical cleaning (e.g., using distilled, deionized water, followed by an organic solvent such as acetone or isopropyl alcohol), optionally in the presence of applied ultrasound.

Advantages of laser ablation of the sacrificial material layer 140 to form the openings 155a-b in the encapsulant layers 160a-b include the following:
Patterning is dry, so there is no effect on the battery layers or their chemistry
The sidewalls of the openings 155a-b may be sloped, facilitating the formation of a via or interconnect therein
Patterning throughput is typically higher than photolithography due to the relatively high laser scan rate
Lower cost, due to the elimination of lithography and/or shadow masks
Patterning flexibility is maximized, as laser ablation is driven by a graphical drawing, which is easy and fast to change relative to photolithography and shadow masks.

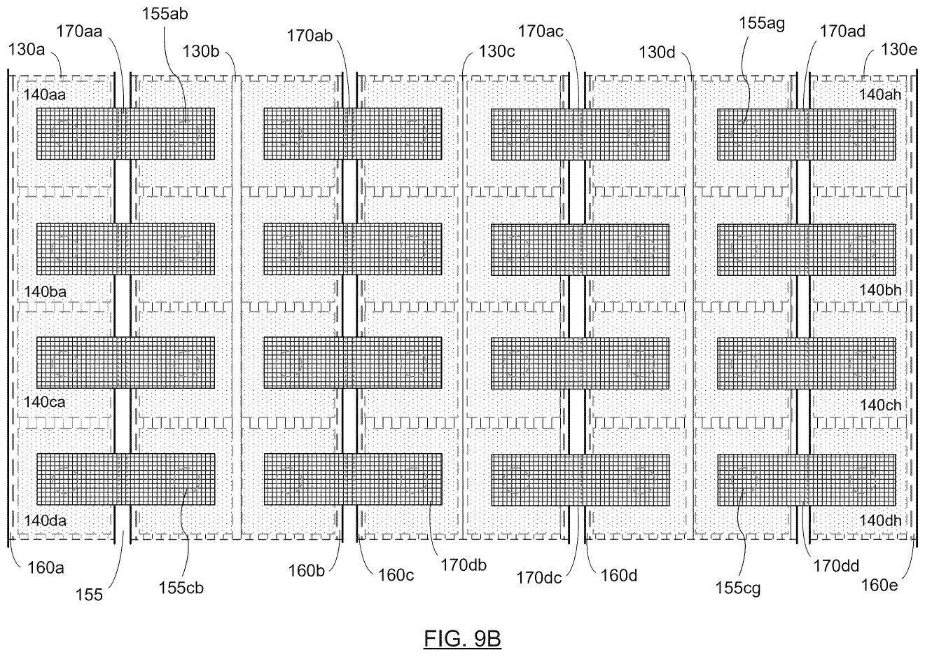

FIG. 9A shows formation of a metal redistribution layer 170 along the ACC edges (in the opening 146′; see FIG. 8) and in the openings 155b-c in the encapsulant films 160a-b to connect the ACCs 140a-d to a subsequently formed external battery terminal. The redistribution layer 170 may comprise Cu, Ni, Al, Ti, V, or another suitable and/or stable (e.g., lithium-compatible and/or air- and/or water-stable) metal, and may be formed by sputtering, ALD or thermal evaporation through a mask that exposes a region of the cell corresponding to the pattern of the redistribution layers 170aa-dd (FIG. 9B), followed by removal of the mask; by blanket deposition, followed by photolithographic patterning and etching (as described herein); or by selective deposition, such as inkjet printing, aerosol-jet printing or screen printing. Printing may comprise the use of a conventional metal-containing ink or paste. In some embodiments, the length and width dimensions of the redistribution layer 170 (FIG. 9A) or layers 170aa-dd (FIG. 9B) may be on the scale of hundreds of microns (e.g., 200-1000 μm) or several millimeters (e.g., 1-10 mm), thereby enabling selective deposition processes such as inkjet printing, screen printing and shadow masking.

Low electrical resistance and a low curing temperature are desirable for the redistribution layers 170, and the redistribution layers 170 have a thickness typically in the range 0.25-2 μm on the uppermost surface of the cells. Due to liquid flow during printing, the entirety of the openings 155b-c may be filled with metal, which may be beneficial during battery cycling.

A single redistribution layer 170 is on the ACC edges of adjacent cells (i.e., across the opening/gap 146′ between cells defined by ACCs 140b-c; see FIGS. 8 and 9A). The redistribution layers (or ACC redistribution traces) 170 conduct charge carriers between the ACCs 140b-c (exposed through the openings in the encapsulant layers 160a-b) to the ACC edges of the cells, in the opposite direction from the CCC edges/contact surfaces 112a-b (FIG. 10A).

Referring now to FIG. 9B, the ACC redistribution traces 170aa-dd electrically contact the ACCs 140aa-dh through the insulation layer openings 155aa-dh, but are physically and electrically insulated from the CCCs/substrates 110a-b (FIG. 9A) by the encapsulant layers 160a-b. When the ACC redistribution traces 170aa-dd (FIG. 9B) are a metal, they form an intrinsic barrier to ambient ingress in the region of the vias or openings 155aa-dh. The ACC redistribution traces 170aa-dd are both physically on the top surface of the cell and cover at least part of the cell sidewalls. The ACC redistribution traces on the sidewalls (e.g., 172a-b in FIG. 10A) enable subsequent electrical connection of the cells to a terminal on a side or exterior surface of the packaged battery.

In further embodiments involving printing the redistribution layer 170aa-dd (FIG. 9B, prior to printing, the method may further comprise testing the cells to determine battery functionality (e.g., charging, charge holding, and/or discharging properties). Cells that fail testing (i.e., that are identified as non-functional or insufficiently functional) may have the redistribution layer 170 printed differently. For example, if the cells are tested prior to printing the encapsulant film 160, the redistribution layer 170 may be omitted (i.e., not printed) in those cells that fail testing. In other words, when a cell fails testing (i.e., is identified as defective) prior to printing the redistribution layer 170, the ACC layer 140 can simply be left unconnected/unconnectable to the external terminal of the packaged battery.

FIGS. 10A-B show singulated cell strips, exposing CCC contact surfaces 112a-b of the metal foil sheets or rolls 110a and 110b (FIG. 10A). Prior to singulation (dicing), the cell pairs may be placed on a substrate holder (e.g., a magnetic plate or chuck) or an epoxy-coated tape (not shown). In this case, dicing along the CCC edges (to form openings 175a-c, FIG. 10B) creates the single cell strips and exposes the CCC contact surfaces 112a-b (FIG. 10A). Alternatively, dicing along the CCC edges can be performed at the same time as dicing along the ACC edges (FIGS. 6A-B), in which case the encapsulant layers 160a-b and/or the redistribution layer 170 may advantageously be printed (to avoid depositing the encapsulant and redistribution layer material[s] on the CCC edges). The epoxy coating on the tape may be used to keep the individual (i.e., further singulated) cells together during stacking, and may provide a passivation/sealing layer on one side or surface of the stacked cells during packaging. Thus, the coated tape may comprise a die attach film (DAF). Alternatively, an adhesive (e.g., an epoxy adhesive) may be coated or printed onto the upper or lower surface of the battery cells prior to stacking.

Singulation, both of the single-cell strips shown in FIGS. 10A-B and of the individual cells from the single-cell strips may be conducted by laser dicing, mechanical dicing, or stamping. When present, the epoxy coating and the tape may also be cut during singulation. The redistribution layer 170 (FIG. 9A) may be cut or separated (e.g., at the bottom of openings 146′a-d, FIG. 10B) to form individual redistribution layers 170a and 170b (FIG. 10A) either during singulation or during removal (e.g., from a chuck or other deposition/patterning apparatus) at or near the end of the redistribution layer formation process. If necessary or desired, the CCC contact surfaces 112 in the single-cell strips (i.e., defined by encapsulation layers 160a and 160e; see FIG. 9B) can be exposed by polishing or grinding the CCC edges of the single-cell strips.

Both the single-cell strips and the individual singulated cells may be stacked to form a multi-cell stack, with the CCC (substrate) edges 112a-b along one side of the stack, and the ACC edges 172a-b along the opposite side. An adhesive layer (not shown) between cells in the stack can be from the coated tape or from a liquid die attach (DA) or printing process, and can be applied to the back and/or front major surface of the cells (e.g., every other cell), prior to or after cell or cell strip singulation. If not applied as part of a DA process, the adhesive can be applied by methods such as b-stage laminated film formation, dispensing, jetting, inkjet printing, screen printing, etc. The parallel cells in a multi-cell stack each additively contribute to the overall battery capacity. A dummy cell (e.g., an encapsulated metal foil substrate similar or identical to the metal foil, sheet, or substrate 110 or the barrier-covered metal foil, sheet, or roll 110/315) may be placed on top of the stack (e.g., of individually singulated cells) as a moisture and air barrier and to protect the stack from externally-caused damage. Optionally, markings on one major surface of the dummy cell can be used as external product markings.

End terminals at the CCC and ACC edges (e.g., the exposed CCC surfaces 112 and the sidewall sections 172 of the redistribution layers 170, respectively) are dipped into or coated with a conductive epoxy to electrically gang the terminals and form the CCC and ACC terminals of the packaged battery. The conductive epoxy may comprise an Ag-filled or Ni-filled conductive epoxy paste. Alternatively, a pin-to-pin paste transfer method may be used, or a stable and/or noble metal such as Au, Pt, Pd, or Cu can be used in place of the Ag or Ni. Plating a metal onto part or all of the CCC and ACC terminals creates a solderable surface for PCB attachment by the end user. For solderable termination, the epoxy surface may be plated with Ni, Ag, In, Sn, or a combination thereof (e.g., Ni, then with In or Sn). The conductive epoxy may contain a relatively high metal content, which can retard ambient ingress of oxygen or water vapor. Plating the epoxy with one or more pure metal layers may further block such ambient ingress. Both of these features help with ambient air resistance, particularly on the CCC edge, due to the encapsulant film 160 being diced at this edge during cell singulation from the single cell strips (FIGS. 10A-B).

FIGS. 11-12 are cross-sectional views of exemplary structures in an alternative method of making solid-state battery cells, in accordance with one or more alternative embodiments of the present disclosure. Referring back to FIG. 8, the openings 155b-c in the encapsulant layers 160a-b can be filled with a conductive via or contact 180a-b (FIG. 11). The via or contact 180a-b generally comprises a conductive material, such as a metal or metal alloy as described herein, and can be formed in the openings 155b-c using a precision dispensing technique, such as inkjet printing, screen printing, syringe dispensing, etc., using a metal containing ink or paste as described herein, then optionally annealing or curing the conductive material (e.g., under conditions and for a length of time sufficient to improve the electrical conductivity of the vias or contacts 180a-b) prior to formation of the redistribution layer 170′ (FIG. 12). The redistribution layer 170′ is substantially the same as the redistribution layer 170 described herein, except that it is not in the openings 155b-c, and is formed in the same manner as the redistribution layer 170.

Alternatively, referring back to FIG. 8, the vias or contacts 180a-b can be formed by blanket deposition of a conductive material (e.g., an elemental metal or elemental metal alloy) in the openings 155b-c and on the encapsulant layers 160a-b, and the excess conductive material can be removed by planarization (e.g., polishing or grinding). In further alternatives, the conductive vias or contacts 180a-b may be formed on the patterned ACCs 140a-d before the encapsulant. For example, the conductive vias or contacts 180a-b may be formed in a first pattern on the patterned ACC layer, similarly or identically to the patterned sacrificial material 150b-c (see FIG. 5A), then the encapsulant 160a-b (FIG. 7A) deposited on the patterned ACCs 140a-d, the electrolyte 130a-b, and the ACC edges or sidewalls on opposite sides of the gap 146 (FIG. 6A) by either of at least two methods. In a first method, the encapsulant 160a-b is printed (as described herein) in a second pattern including an opening (e.g., in each cell) through which the conductive via or contact is exposed. The openings in the second pattern correspond to (overlap concentrically with) the first pattern, although they may have area dimensions slightly smaller or larger than the corresponding area dimensions of the conductive vias or contacts 180a-b. In a second method, the encapsulant 160a-b may be blanket-deposited on the conductive vias or contacts 180a-b, the patterned ACCs 140a-b, the electrolyte 130a-b, and the ACC edges or sidewalls of the cells, and portions of the encapsulant 160a-b on the uppermost surface of the conductive vias or contacts 180a-b may be removed by planarization.

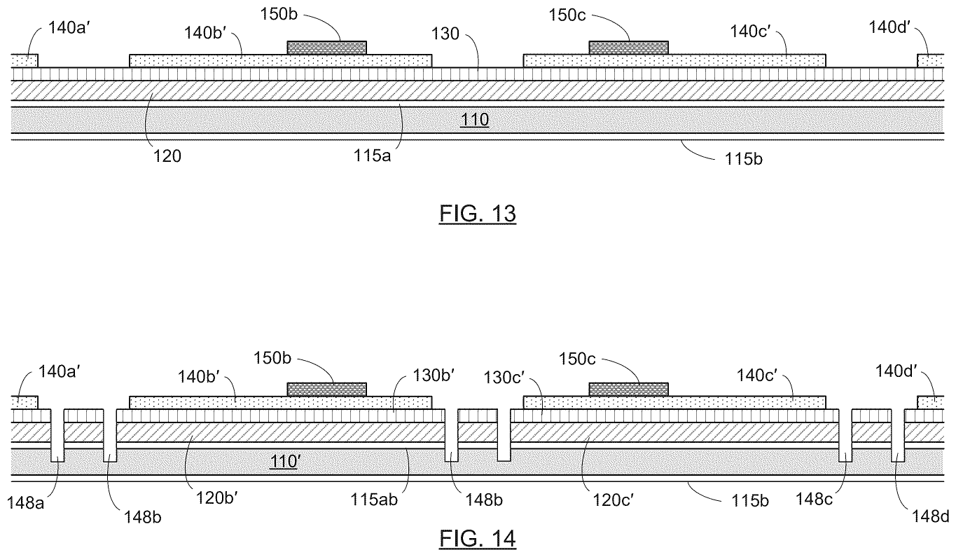

FIGS. 13-16 are cross-sectional views of exemplary structures in a further alternative method of making solid-state battery cells, in accordance with further embodiments of the present disclosure. Referring back to FIG. 4A, the ACCs can be slightly smaller and/or patterned with more space between them, resulting in ACCs 140a′-140d′ with sacrificial material layers 150b-c thereon, as shown in FIG. 13. Isolation channels or moats 148a-d are then formed through the solid-state electrolyte 130, the cathode 120, and the first barrier 115a, and into the substrate 110, as shown in FIG. 14. The isolation channels or moats 148a-d surround the ACCs 140a′-140d′ in a layout view, and may be 0-20 μm (or any distance or range of distances therein) away from the peripheral edge of the ACCs 140a′-140d′. The isolation channels or moats 148a-d may have a width of 2-10 μm (or any width or range of widths therein), and may penetrate into the substrate 110 at a depth of from 10-75% (or any percentage or range of percentages therein) of the thickness of the substrate 110. The isolation channels or moats 148a-d may be formed by laser ablation, but other methods may also be suitable.

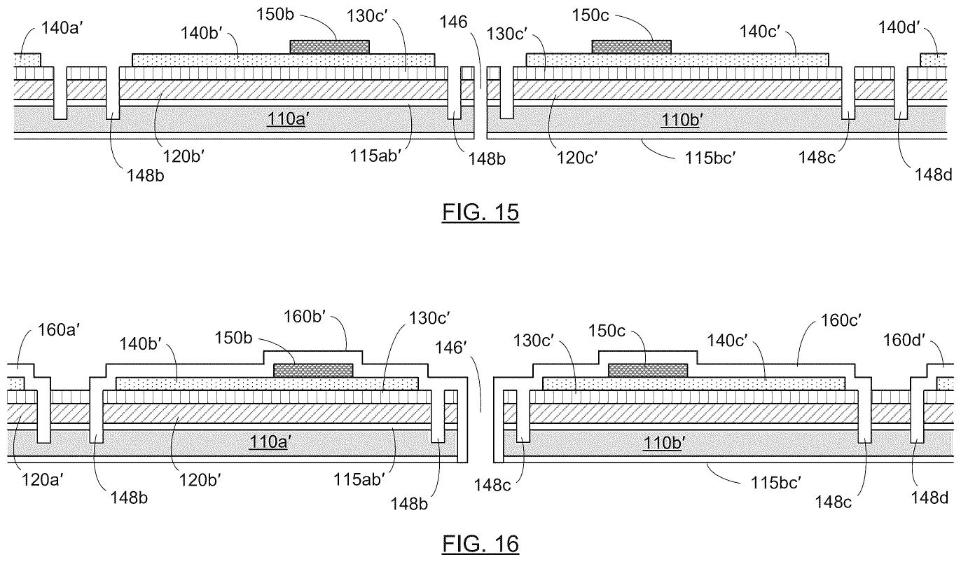

Referring now to FIG. 15, the structure of FIG. 14 is cut or diced along certain lanes (e.g., lanes 142a, 142c, 142e, and 142g in FIG. 5B) to form “ACC edges” of the battery cells and gaps 146 every other cell, or every other row or column of cells, as described with respect to FIGS. 6A-B. Referring now to FIG. 16, encapsulant films 160a′-160d′ are formed on the sacrificial material layers 150b-c, the ACCs 140a′-140d′ and the electrolytes 130a′-130d′, and along the ACC edges of the battery cells in the gaps 146 by selective deposition, as described herein (e.g., inkjet printing, screen printing, spray coating, extrusion coating, slot-die coating, etc.). The materials for the encapsulant films 160a′-160d′ are substantially the same as for encapsulant films 160a-160b, described with respect to FIGS. 7A-B, but formulated for selective deposition (e.g., in the liquid phase). Alternatively, the materials for the encapsulant films 160a′-160d′ may be simply coated (e.g., spray-coated, spin-coated, extrusion-coated, blanket-deposited, etc.) on the upper and side surfaces of the cell pairs or cell row/column pairs, thus covering the spaces between adjacent moats 148. Thereafter, the openings 155 in the encapsulant films 160a-160b, the redistribution layer 170, and optionally the via or contact material 180 are formed in substantially the same manner as described elsewhere herein.

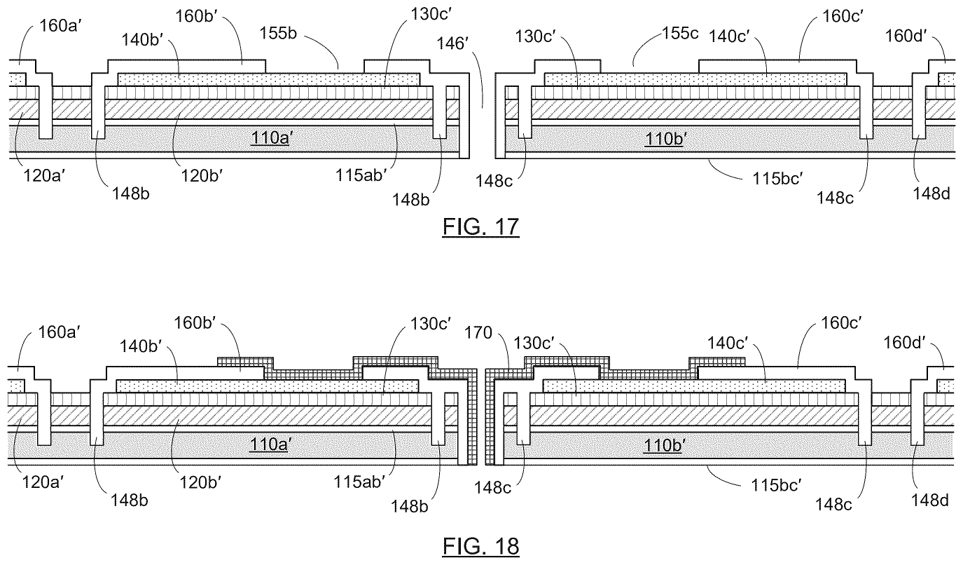

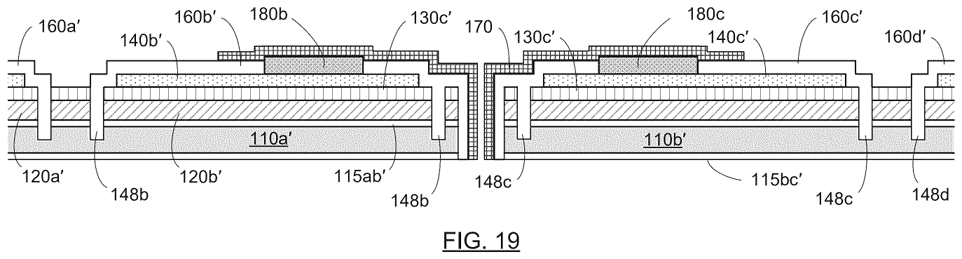

Referring now to FIG. 17, portions of the encapsulant films 160b′ and 160c′ that were aligned/positioned over the the sacrificial material layers 150b and 150c are removed (together with the sacrificial material layers 150b and 150c) creating the openings 155b and 155c and exposing portions of the anode current collector layers 140b′ and 140c′. Referring now to FIG. 18, redistribution layers 170 are formed over the encapsulant films 160b′ and 160c′ and extending into the openings 155b and 155c thereby forming direct physical and electrical contacts with the anode current collector layers 140b′ and 140c′ in these openings. FIG. 19 illustrates a variation in which, contact material 180b and 180c is positioned within the openings 155b and 155c and between the the anode current collector layers 140b′ and 140c′ and redistribution layers 170, e.g., to enhance the electrical contact between these layers.

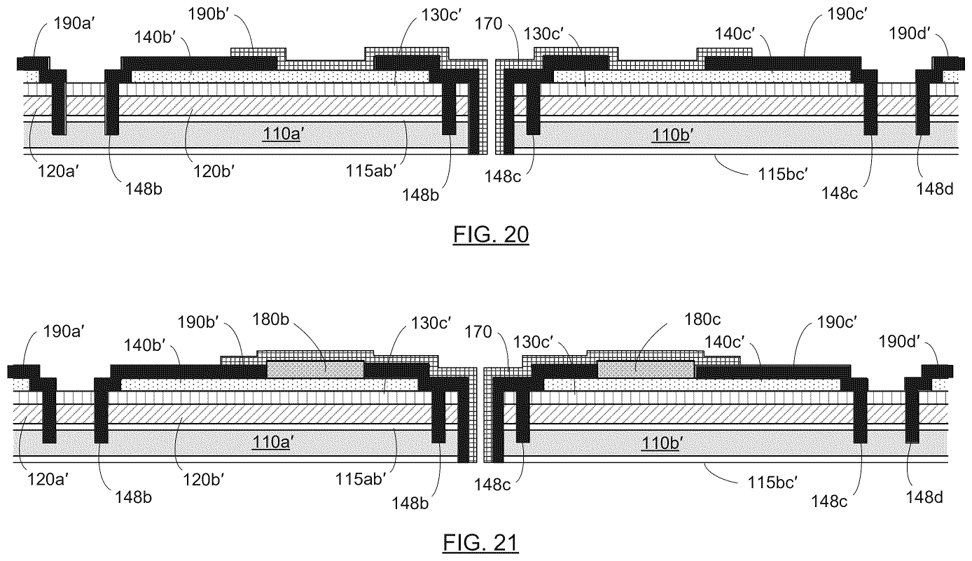

FIGS. 20 and 21 illustrate a variation in which encapsulant films 160b′ and 160c′ are replaced with a moisture barrier layer 190. In such embodiments, the moisture barrier layer 190 functions as an environmental barrier protecting the solid-state battery cell from ambient moisture and oxygen ingress (and potentially as an electrical insulator). Some examples of moisture barrier layer 190 include, but are not limited to, polymeric or hybrid barrier materials such as polyimides, poly(meth)acrylates, polycarbonates, epoxy-based insulating resins, poly-para-xylylene (parylene), halogenated parylenes such as parylene-C or parylene-F, silicone-based insulating polymers, and cross-linked photoresists. In other embodiments, the moisture barrier layer 190 may comprise inorganic or hybrid materials such as silicon oxide (SiO₂), silicon nitride (SiNₓ), aluminum oxide (Al₂O₃), silicon oxynitride, or multilayer combinations thereof. The moisture barrier layer 190 may be deposited using a selective deposition process, for example inkjet printing, aerosol-jet printing, screen printing, syringe dispensing, or nozzle dispensing. Selective deposition may provide improved control over the location and geometry of the moisture barrier layer 190 relative to the battery cell structures. For example, the moisture barrier layer 190 may be selectively deposited along regions adjacent to the anode current collectors 140b′ and 140c′, along the sidewalls of the battery cell, or within isolation channels or moats formed around the cells. In some embodiments, the moisture barrier layer 190 may partially or completely fill such moats or channels, thereby forming a lateral moisture barrier that reduces the likelihood of moisture ingress through exposed sidewalls of the battery stack. Compared to blanket-deposited encapsulant films such as 160b′ and 160c′, selective deposition of the moisture barrier layer 190 can reduce material consumption, improve pattern fidelity, and allow barrier material to be positioned only where environmental protection is most beneficial.

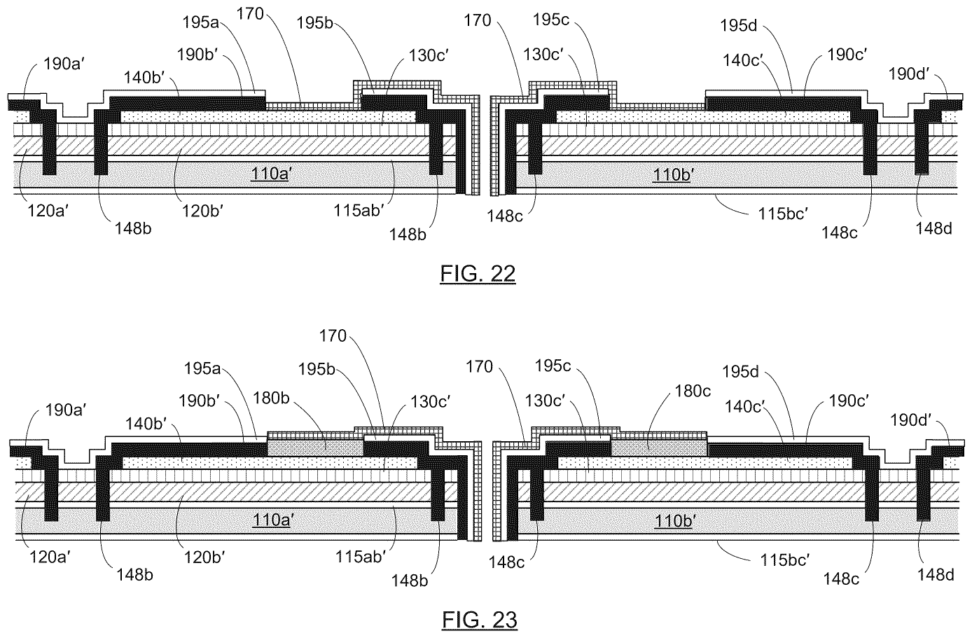

FIGS. 22 and 23 illustrate a further variation in which encapsulant films 160b′ and 160c′ are combined with moisture barrier layer 190 to form a multilayer encapsulation structure. In these embodiments, the moisture barrier layer 190 is deposited first, followed by deposition of encapsulant films 160b′ and 160c′ over the moisture barrier layer 190 and surrounding regions. The moisture barrier layer 190 may be selectively deposited, for example by inkjet printing, aerosol-jet printing, screen printing, syringe dispensing, nozzle dispensing, or other precision dispensing techniques, in regions such as isolation channels or moats surrounding the battery cells or adjacent to exposed sidewalls of the anode current collector layers 140b′ and 140c′. The encapsulant films 160b′ and 160c′ may then be deposited as blanket or conformal layers, for example by chemical vapor deposition, spin coating, spray coating, extrusion coating, or other coating techniques. In certain examples, the encapsulant films 160b′ and 160c′ comprise parylene or another conformally deposited polymeric insulating film that covers the upper surfaces of the battery cells and sidewall regions. Depositing the moisture barrier layer 190 prior to the encapsulant films 160b′ and 160c′ may improve adhesion between layers and reduce delamination or mechanical failure of the encapsulation structure. In addition, the multilayer encapsulation may provide improved resistance to moisture and oxygen ingress. For example, the selectively deposited moisture barrier layer 190 may block lateral diffusion of moisture through the sidewalls or moat regions, while the encapsulant films 160b′ and 160c′ serve as a primary environmental barrier covering the top surfaces of the cells. Such multilayer barrier structures may be particularly advantageous for thin-film solid-state batteries that are sensitive to ambient moisture, providing improved environmental stability and extended device lifetime.

### CONCLUSION

The foregoing descriptions of specific embodiments of the present disclosure have been presented for purposes of illustration and description. They are not intended to be exhaustive or to limit the disclosed features, and obviously, many modifications and variations are possible in light of the above teaching. The embodiments were chosen and described in order to best explain the principles of the disclosure and its practical application, to thereby enable others skilled in the art to best utilize the disclosure and various embodiments with various modifications as are suited to the particular use contemplated.

1. A method of making solid-state battery cells, comprising:
forming a patterned anode current collector (ACC) layer on a solid-state electrolyte, wherein the solid-state electrolyte is on a cathode layer, and the cathode layer is on a substrate,
forming a sacrificial material in a first pattern on the patterned ACC layer,
depositing an insulating encapsulant material on the sacrificial material and the patterned ACC layer, and
irradiating the sacrificial material with a laser sufficiently to ablate the sacrificial material and form openings in the encapsulant material, exposing a part of each ACC in the patterned ACC layer, wherein the openings in the encapsulant material are in a second pattern corresponding to or substantially corresponding to the first pattern.

2. The method of claim 1, further comprising blanket-depositing the cathode layer on the substrate, and blanket-depositing the solid-state electrolyte on the cathode layer.

3. The method of claim 1, wherein forming the sacrificial material in the first pattern comprises (i) selective deposition or (ii) blanket deposition and photolithographic patterning.

4. The method of claim 1, wherein the laser is a programmable laser patterning device, and the method further comprises programming the programmable laser patterning device to irradiate locations of the first pattern with a dose of light having a wavelength absorbed by the sacrificial material sufficient to ablate the sacrificial material and remove the encapsulant material above the sacrificial material.

5. The method of claim 4, wherein the wavelength is in a range from 240 nm to 1400 nm, the laser has a pulse length of from 5 femtoseconds to 1000 ns, a pulse frequency in a range of 10⁵-10¹⁴ Hz, and a laser power in a range of 10-1000 W.

6. The method of claim 1, wherein the encapsulant material is also deposited along ACC edges or sidewalls of the solid-state battery cells, and the method further comprises forming a redistribution layer on (i) the part of the ACC exposed through the opening and (ii) the encapsulant, including along the ACC edge or sidewall.

7. The method of claim 6, wherein the redistribution layer comprises an elemental metal or an alloy thereof, the redistribution layer has a thickness of 0.25-2.0 μm, and the redistribution layer is formed by (i) selective deposition or (ii) sputtering, atomic layer deposition (ALD), or thermal evaporation, followed by photolithographic patterning and etching.

8. The method of claim 1, further comprising cutting or dicing the solid-state battery cells through the electrolyte and the cathode layer to form a cathode in each of the solid-state battery cells and to singulate the solid-state battery cells, stacking the singulated battery cells so that ACC edges or sidewalls of the solid-state battery cells are on a first side of the stacked battery cells and CCC edges or sidewalls of the solid-state battery cells are on a second side of the stacked battery cells, and packaging the stacked battery cells.

9. The method of claim 1, wherein forming the patterned ACC layer comprises blanket-depositing an ACC material and laser-patterning the ACC material using a second programmable laser patterning device programmed to form polylines in the ACC material.

10. The method of claim 9, wherein the polylines comprise a first plurality of parallel lines along a first direction and a second plurality of parallel lines along a second direction, the second direction being orthogonal to the first direction, the first and second pluralities of parallel lines independently having a width of 2-500 μm.

11. The method of claim 1, wherein the cathode layer comprises a lithium metal oxide or lithium metal phosphate.

12. The method of claim 1, wherein the solid-state electrolyte comprises lithium phosphorus oxynitride (LiPON), carbon-doped LiPON, Li₂WO₄, or one or more layers of a lithium lanthanum zirconium oxide (LLZO) in which some of Zr may be substituted with one or more of niobium, tantalum, aluminum, gallium, indium, vanadium, antimony, or hafnium.

13. The method of claim 1, wherein the patterned ACC layer comprises a conductive metal, an alloy of one or more conductive metals, or graphite, the patterned ACC layer is incapable of forming an alloy with lithium, and the patterned ACC layer has a thickness of 0.1-5 μm.

14. The method of claim 1, wherein the substrate comprises a metal foil having a thickness of 10-100 μm, and the metal foil functions as a cathode current collector in the solid-state battery cells.

15. A method of making solid-state battery cells, comprising:
forming a patterned anode current collector (ACC) layer on a solid-state electrolyte, wherein the solid-state electrolyte is on a cathode layer, and the cathode layer is on a substrate,
forming a conductive via or contact and an insulating encapsulant on the patterned ACC layer, the encapsulant (i) surrounding and exposing the conductive via or contact and (ii) further being on the solid-state electrolyte and along ACC edges or sidewalls of the solid-state battery cells, and
forming a redistribution layer on the conductive via or contact and the encapsulant, including along the ACC edge or sidewall.

16. The method of claim 15, wherein forming the conductive via or contact and the insulating encapsulant on the patterned ACC layer comprises:
depositing the encapsulant on the patterned ACC layer, the electrolyte, and the ACC edges or sidewalls,
forming an opening in the encapsulant, exposing the patterned ACC layer, and
either (i) depositing a metal-containing ink or paste in the opening by a precision dispensing technique, then optionally annealing or curing the metal-containing ink or paste, or (ii) blanket depositing a conductive material into the opening and onto the encapsulant, and removing excess conductive material from an uppermost surface of the encapsulant by planarization.

17. The method of claim 15, wherein forming the conductive via or contact and the insulating encapsulant on the patterned ACC layer comprises:
forming the conductive via or contact in a first pattern on the patterned ACC layer,
depositing the encapsulant on the patterned ACC layer, the electrolyte, and the ACC edges or sidewalls by either:
printing the encapsulant in a second pattern, including an opening through which the conductive via or contact is exposed, or
blanket-depositing the encapsulant on the conductive via or contact, the patterned ACC layer, the electrolyte, and the ACC edges or sidewalls, and removing the encapsulant from an uppermost surface of the conductive via or contact by planarization.

18. A solid-state battery cell, comprising:
a substrate,
a cathode on the substrate,
a solid-state electrolyte on the cathode, wherein the electrolyte and the cathode are co-extensive,
an anode current collector (ACC) on the solid-state electrolyte,
an encapsulant on the ACC, the solid-state electrolyte with a fractured opening therein exposing an upper surface of the ACC, and
a redistribution layer electrically connecting the ACC to a first sidewall of the solid-state battery cell.

19. The solid-state battery cell of claim 18, wherein the encapsulant is on the first sidewall of the solid-state battery cell, covering sidewalls of the ACC, the electrolyte, and the cathode, and the redistribution layer is on the encapsulant on the first sidewall.

20. The solid-state battery cell of claim 18, wherein the substrate comprises a metal substrate, and the metal substrate has an exposed sidewall surface on a second sidewall of the solid-state battery cell, opposite from the first sidewall.
